(19) United States
(12) Patent Application Publication
(10) Pub. No.: US 2016/0005025 A1
(43) Pub. Date: Jan. 7, 2016

(54) BILL/ITEM PAYMENT-FOR-ANOTHER

(71) Applicant: EBAY INC., San Jose, CA (US)

(72) Inventor: Kamal Zamer, San Jose, CA (US)

(21) Appl. No.: 14/324,775

(22) Filed: Jul. 7, 2014

(51) Int. Cl. G06Q 20/32; G06Q 20/04; G06Q 30/02; G06Q 20/10

(52) U.S. Cl. CPC G06Q 20/3224; G06Q 20/102; G06Q 20/0453; G06Q 30/0253

(57) ABSTRACT

Bill/item payment-for-another systems and methods include receiving a find-users request from a first user device that is associated with first user information, and that find-users request is directed to a physical merchant location that is associated with merchant information. A second user device is then determined to be located at the physical merchant location. Second user information is then retrieved using an identifier of the second user device. The second user information is provided for display on the first user device. A purchase request is then received from the first user device of at least one item for a second user that is associated with the second user information. A payment amount is then transferred for the at least one item from a first user account that is associated with the first user information to a merchant account that is associated with the merchant information.

### BACKGROUND

1. Field of the Disclosure

The present disclosure generally relates to online and/or mobile payments, and more particularly to systems and methods for payment a bill or item for another person using online and/or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why online and mobile purchases are growing very quickly.

In some situations, a first customer of a merchant may wish to pay for one or more items or an entire bill for a second customer of the merchant. For example, the first customer may wish to “pick up”, “cover”, or otherwise provide a payment for item(s) associated with a bill of the second customer by buying a drink for the second customer, or paying for one or more items previously ordered by the second customer. Traditionally, in order to accomplish such payments by the first customer for the second customer, the first customer and the second customer must order together such that they are associated with the same bill (and the first customer may then pay for that bill). When the first customer and the second customer are not together, the first customer must purchase the item(s) on their bill and have those item(s) sent to the second customer. Such traditional systems are cumbersome and inefficient, and lack the ability to quickly and easily identify the first customer and/or the second customer to each other. For example, such identification typically requires the first customer physically point out the second customer to the merchant, and the merchant physically point out the first customer to the second customer.

Thus, there is a need to improve bill/item payments for others.

### BRIEF DESCRIPTION OF THE FIGURES

FIG. 1 is a schematic top view illustrating an embodiment of a physical merchant location.

FIG. 2 is a schematic view illustrating an embodiment of a beacon device;

FIG. 3a is a schematic top view illustrating an embodiment of a beacon system that includes a plurality of the beacon devices of FIG. 2 in the physical merchant location of FIG. 1;

FIG. 3b is a schematic top view illustrating an embodiment of a portion of a bill/item payment-for-another system with the beacon system of FIG. 3a providing a plurality of communication areas;

FIG. 4 is a flow chart illustrating an embodiment of a method for providing for the payment of a bill/item by a first user for a second user;

FIG. 5a is a screen shot illustrating an embodiment of a physical merchant location provisioning screen displayed on a user device;

FIG. 5b is a screen shot illustrating an embodiment of a physical merchant location action screen displayed on a user device;

FIG. 5c is a screen shot illustrating an embodiment of a user detection screen displayed on a user device;

FIG. 5d is a screen shot illustrating an embodiment of a user information preview screen displayed on a user device;

FIG. 5e is a screen shot illustrating an embodiment of a user information preview screen displayed on a user device;

FIG. 5f is a screen shot illustrating an embodiment of a user information screen displayed on a user device;

FIG. 5g is a screen shot illustrating an embodiment of a bill/item payment-for-another screen displayed on a user device;

FIG. 5h is a screen shot illustrating an embodiment of a bill/item payment-for-another confirmation screen displayed on a user device;

FIG. 6 is a screen shot illustrating an embodiment of a bill/item payment-for-another authorization screen displayed on a merchant device;

FIG. 7a is a screen shot illustrating an embodiment of a bill/item payment-for-another authorization screen displayed on a user device;

FIG. 7b is a screen shot illustrating an embodiment of a bill receipt screen displayed on a user device;

FIG. 7c is a screen shot illustrating an embodiment of a bill receipt screen displayed on a user device;

FIG. 8 is a screen shot illustrating an embodiment of a payment request confirmation screen displayed on a user device;

FIG. 9 is a schematic view illustrating an embodiment of a networked system;

FIG. 10 is a perspective view illustrating an embodiment of a user device;

FIG. 11 is a schematic view illustrating an embodiment of a computer system; and

FIG. 12 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing for the payment of some or all of a bill of a second user by a first user in order to allow that first user to “pick up” or “cover” some or all of the bill of the second user. Embodiments of the systems and methods may include receiving a request from the first user for second users at a physical merchant location and, in response, determining a plurality of second user devices that are located at the physical merchant location. For each second user device located at the physical merchant location, respective second user information may be retrieved and provided for display on a first user device of the first user. The first user may select from the second user information to designate the second user for whom the first user wishes to provide a payment for one or more items on the bill, and may select one or more items for purchase for that second user. The selection of one or more items by the first user (e.g., from a bill of the second user, from a menu of the merchant, etc.) results in a purchase request for the one or more items being sent by the first user device and, in response, a payment amount for those one or more items may be transferred from a first user payment account of the first user to a merchant payment account of the merchant. The systems and method provide quick and easily bill/item payment-for-another notifications to the merchant and, in some embodiments, the second user, and may allow the merchant and/or the second user to authorize or confirm the purchase by the first user. Furthermore, for open-ended purchases by the first user (e.g., a purchase request by the first user to pay for an item that may be selected by the second user), confirmation may be requested and received from the first user.

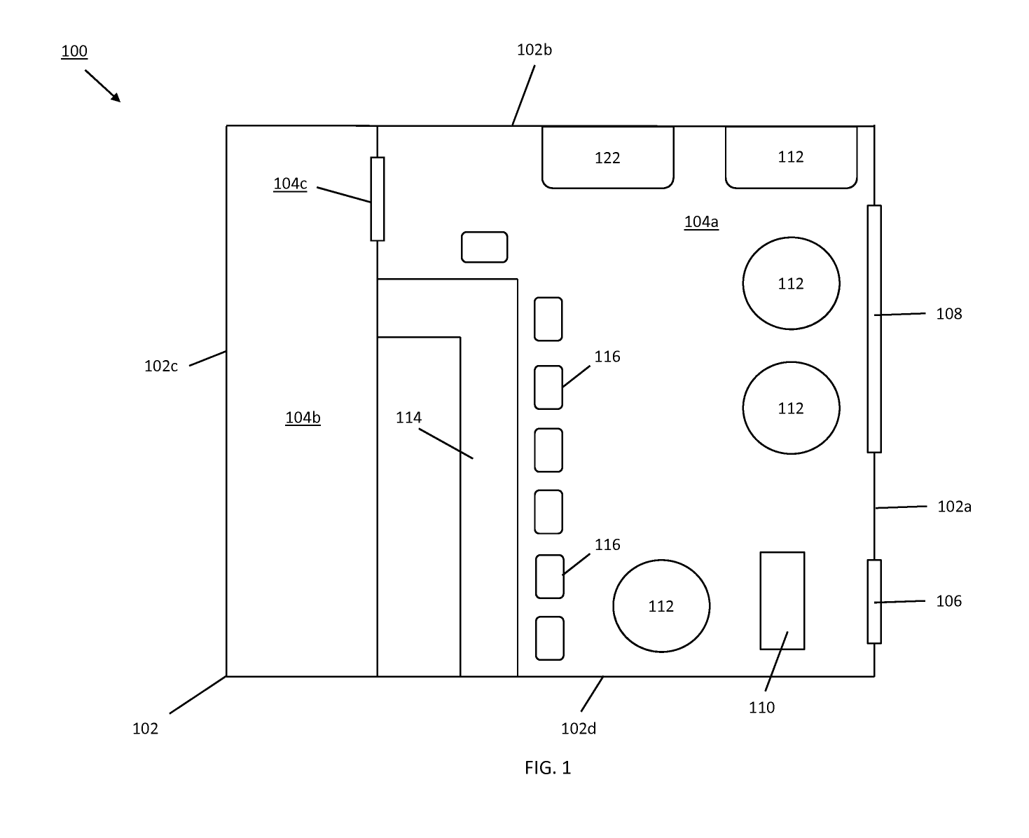

Referring now to FIG. 1, an embodiment of a physical merchant location 100 is illustrated. The physical merchant location 100 includes a merchant building 102 having a plurality of exterior walls 102a, 102b, 102c, and 102d that define a physical merchant location interior 104 having a customer area 104a and an employee area 104b, along with a door 104c providing access between the customer area 104a and the employee area 104b. The exterior wall 102a includes an exterior door 106 (e.g., a “front” door in the illustrated embodiment) and an exterior window 108. The customer area 104a includes a reception area 110, tables 112, a bar area 114, and bar seats 116.

In the examples discussed below, the physical merchant location 100 is a restaurant/bar, the employee area 104b is a kitchen, and the customer area 104 is a dining area/bar. However, while the specific example of a restaurant/bar is provided and discussed below to provide an example of one use of the bill/item payment-for-another system of the present disclosure, one of skill in the art in possession of the present disclosure will recognize that a wide variety of physical merchant locations will benefit from the teachings of the present disclosure, and any physical merchant location in which a merchant may generate an invoice, tab, or bill for a second user, including retail stores, grocery stores, and/or other non-restaurant/bar type locations that are the focus of the discussion below, are envisioned as falling within the scope of the present disclosure.

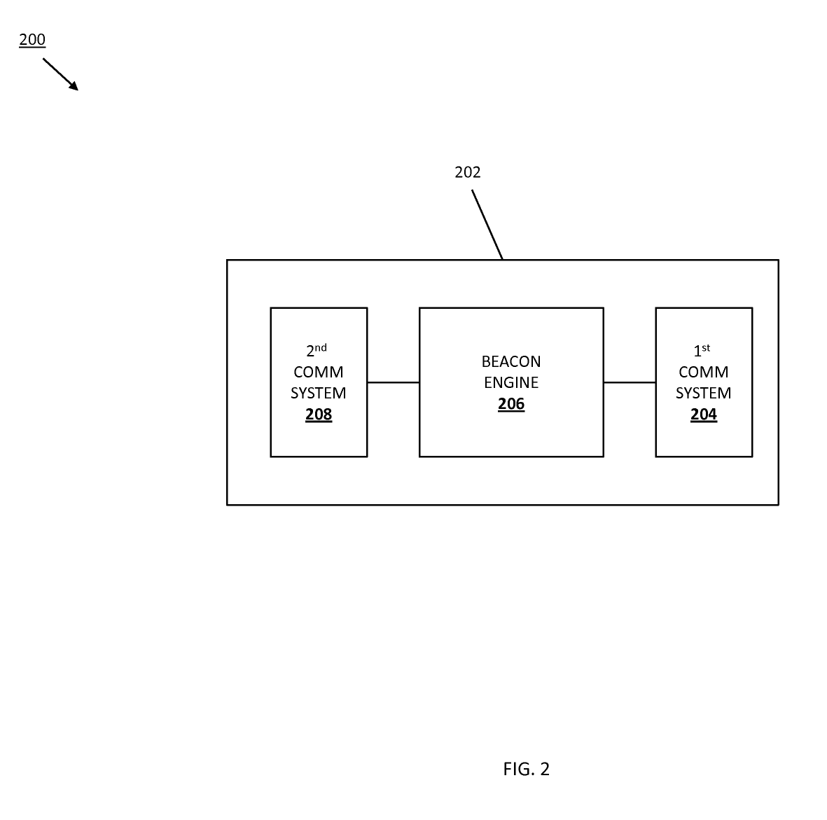

Referring now to FIG. 2, an embodiment of a beacon device 200 is illustrated. The beacon device 200 includes a chassis that houses a first communications system 204 such as, for example, a Wifi communications system, a cellular communication system, and/or a variety of other communication systems known in the art. The first communications system 204 is coupled to a beacon engine 206 that may be provided by instructions on a memory system (not illustrated) in the beacon device 200 that, when executed by a processing system (not illustrated) in the beacon device 200, cause the processing system to perform the functions of the beacon devices 200 discussed below. The beacon engine 206 is coupled to a second communication system 208 such as, for example, a Bluetooth® Low Energy (BLE) communication system, a BLE direct communication system, a Wifi direct communication system, a Near Field Communication (NFC) system, and/or a variety of other communication systems known in the art. The beacon engine 206 may be configured to receive any of a variety of signals through the second communication system 208 and transmit those signals using the first communication system 204. While a few examples of communications components in the beacon device 200 have been described, one of skill in the art will recognize that other communications devices, as well as other components that have been omitted for clarity of discussion and illustrated, may be included in the beacon device 200 and will fall within the scope of the present disclosure. One of skill in the art will recognize that the components described above allow for the beacon device 200 to be provided in a relatively small form factor such that it may be placed inconspicuously almost anywhere. The chassis 202 of the beacon device 200 may include any of a variety of features that allow for the coupling of the beacon device to different areas in the physical merchant location 100, discussed below.

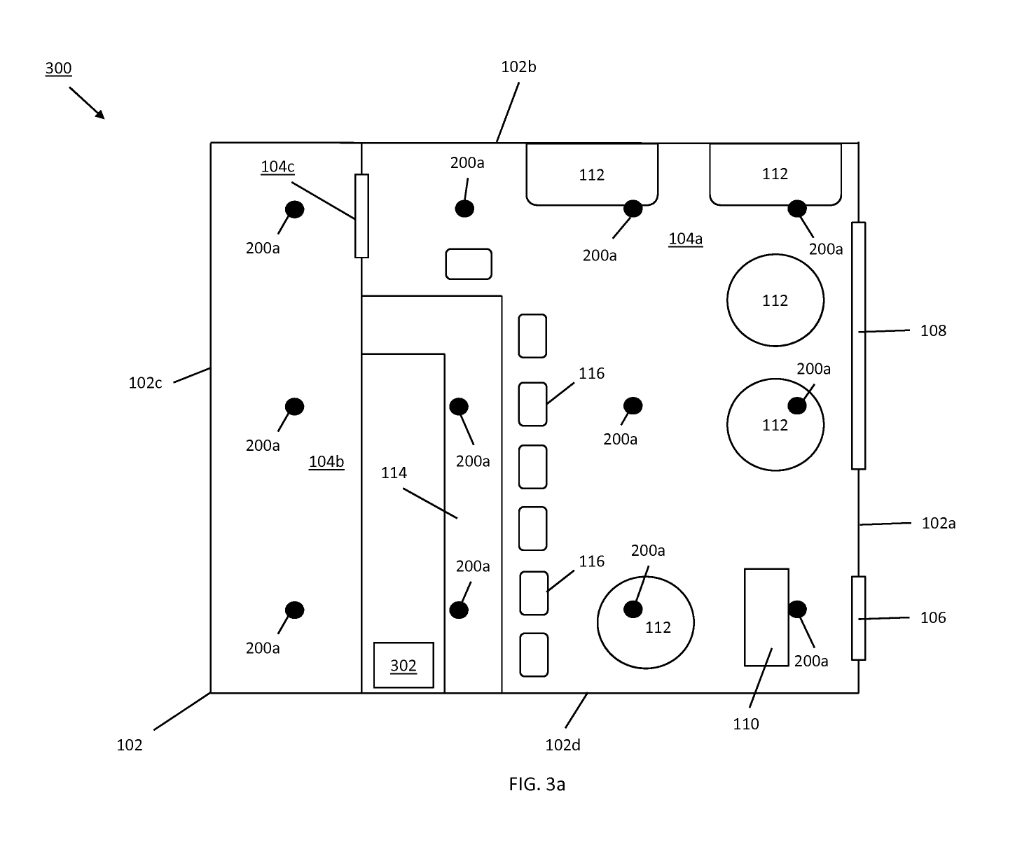

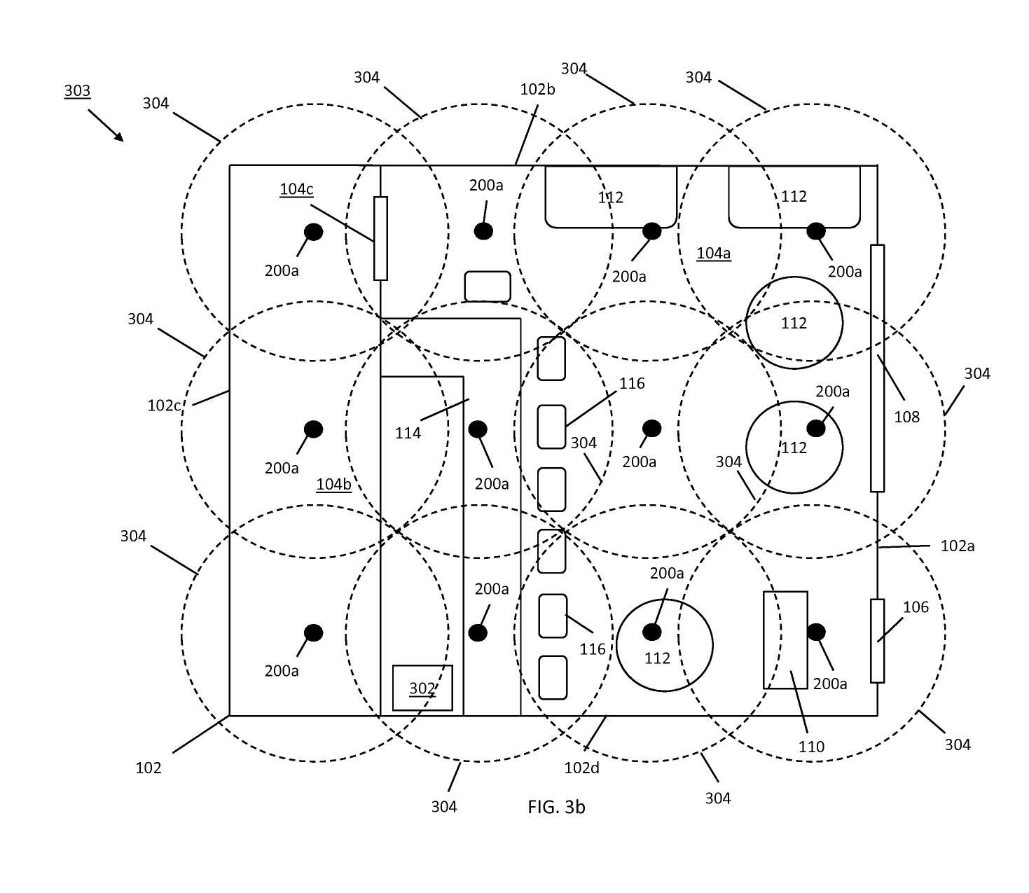

Referring now to FIGS. 3a and 3b, an embodiment of a beacon system 300 is illustrated. As illustrated in FIG. 3a, the beacon system 300 may be provided by positioning a plurality of the beacon devices 200, discussed above with reference to FIG. 2, in and around the physical merchant location 100, discussed above with reference to FIG. 1. In the illustrated embodiment, a plurality of the beacon devices 200a are positioned in and around the physical merchant location 100. As discussed above, the beacon devices 200a may be sized such that they may be inconspicuously positioned virtually anywhere in or around the physical merchant location 100. For example, the beacon devices 200a may be positioned on the ceiling of the physical merchant location 100, under or on tables 112 and/or the bar area 114, and virtually anywhere else in the physical merchant location 100. Each of the beacon devices 200a in the beacon system 300 may be configured to wirelessly communicate, via its first communications system 204, with a merchant network communication device 302 such as, for example, a Wifi wireless router connected to a network such as the Internet, and merchant device connected to one or more networks, and/or a variety of other network communication devices known in the art. As such, the merchant network communication device 302 may also include a variety of computing devices such as desktop computing systems, laptop/notebook computing systems, server computing systems, and/or a variety of other computing systems known in the art.

Referring now to FIG. 3b, the operation of the beacon system 300 may provide a portion 303 of the bill/item payment-for-another system discussed in further detail below. Each of the beacon devices 200a is configured to create a communication area 304 using its second communications system 208. For example, the second communications system 204 in each beacon device 200a may be a BLE communications device that provides an approximately 100 foot radius communications area. However, other communications systems providing other communications areas are envisioned as falling within the scope of the present disclosure. As can be seen in the illustrated embodiment, the beacon devices 200a may be positioned in and around the physical merchant location 100 such that the communications areas 304 abut, overlap, or otherwise provide coverage for any area of interest within and around the physical merchant location 100. As such, different configurations of the beacon devices 200a within and around the physical merchant location 100 may be selected to cover any area within and around the physical merchant location 100 with a communications area 304. As discussed in further detail below, each of the beacon devices 200a are configured to communicate with user devices within their respective communications area 304 (e.g., using the second communication system 208) to collect data, and then send that data to the merchant network communication device 302 (e.g., using the first communication system 204) such that the data may be provided to a merchant device, a system provider device, and/or any other device operating to provide the display of automatic payment codes as discussed below. One of skill in the art will recognize that the use of BLE communication devices or BLE direct communication devices for communication between the beacon devices 200a and user devices may be utilized to provide for low power communications via a background communication process with a user device (e.g., when the user device is not being actively used by the user, or when the user device is being used for reasons other than communication with the beacon device 200a and without instruction from the user to communicate with the beacon devices 200a.)

In the embodiments illustrated and discussed below, the beacon devices 200 and their communications areas 304 are not illustrated for clarity of illustration and discussion, but it should be understood that the communications between and retrieval of information from user devices by the beacon system 300, and that provision of that information to a system provider device such as the payment service provider devices discussed below, may be accomplished using beacon devices providing communications areas such as the beacon devices 200 and communications areas 304 illustrated in FIGS. 3a and 3b. However, in some embodiments, the beacon devices 200a may be omitted from the portion 303 of the bill/item payment-for-another system and any communications between the user devices and the system provider devices may be provided over other networks (e.g., Local Area Networks (LANs), the Internet, cellular networks, etc.) Thus, while a specific example of a portion 303 of the bill/item payment-for-another system is provided, one of skill in the art in possession of the present disclosure will recognize that a wide variety of different physical merchant locations may incorporate the beacon devices 200 or other communication systems in a variety of manners while remaining within its scope.

In the embodiments discussed below, the bill/item payment-for-another system and methods involve a system provider such as a payment service provider using a system provider device such as a payment service provider device to retrieve information collected by the beacon devices 200 from user devices through a network (e.g., the Internet). In such embodiments, the system provider may associate the physical merchant location 100 (or its merchant), the beacon devices 200, merchant devices, and/or other components of the system with a merchant account or a physical merchant location account in a database located in a non-transitory memory. As such, information received from the beacon devices and merchant devices may be associated with the merchant account or physical merchant location account in the database, and any of that information may be stored in associated with that merchant account or physical merchant location account. In other embodiments, the system provider device may be a merchant device that is local to the physical merchant location 100 and that communicates with the beacon devices 200 using the merchant network communication device 302.

FIGS. 1, 3a, and 3b illustrate a physical merchant location 100 that is a single building, and the beacon devices 200a are positioned to provide communications areas 304 that cover the interior of that single building and an area outside the front of that single building. However, beacon devices 200 may be positioned virtually anywhere to retrieve information associated with a physical merchant location 100. For example, the physical merchant location 100 may be located adjacent to or associated with a parking lot, and beacon devices may be positioned around that parking lot, at the entrances or exits of that parking lot, and/or anywhere else relative to that parking lot in order to communicate with user devices, exchange information with user devices, and provide information to the system provider device. In another example, the physical merchant location may be located in a mall, and beacon devices may be positioned around that mall, at the entrances or exits of that mall, and/or anywhere else relative to that mall in order to communicate with user devices, exchange information with user devices, and provide information to the system provider device. In some examples, the first communication system may be connected to Wifi networks available outside the physical merchant location in order to communicate and exchange information with the user devices. In other examples, the first communication system may be a cellular communications system that allows the beacon devices to be positioned anywhere in range of a cellular communications tower, allowing beacon devices associated with the merchant to be positioned in virtually any physical location when providing the bill/item payment-for-another system.

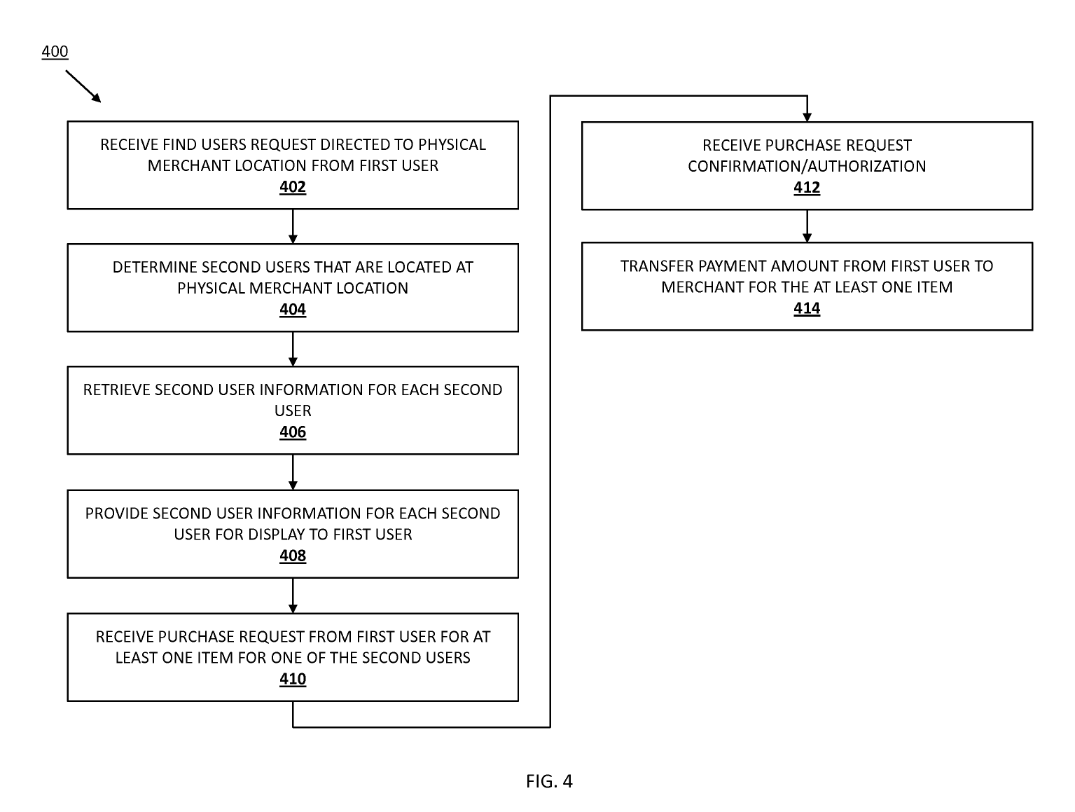

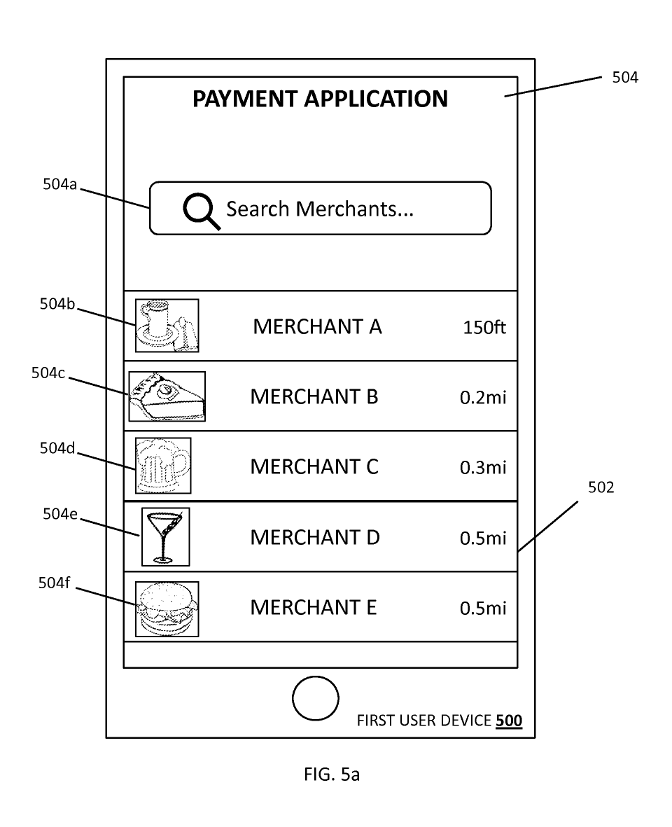

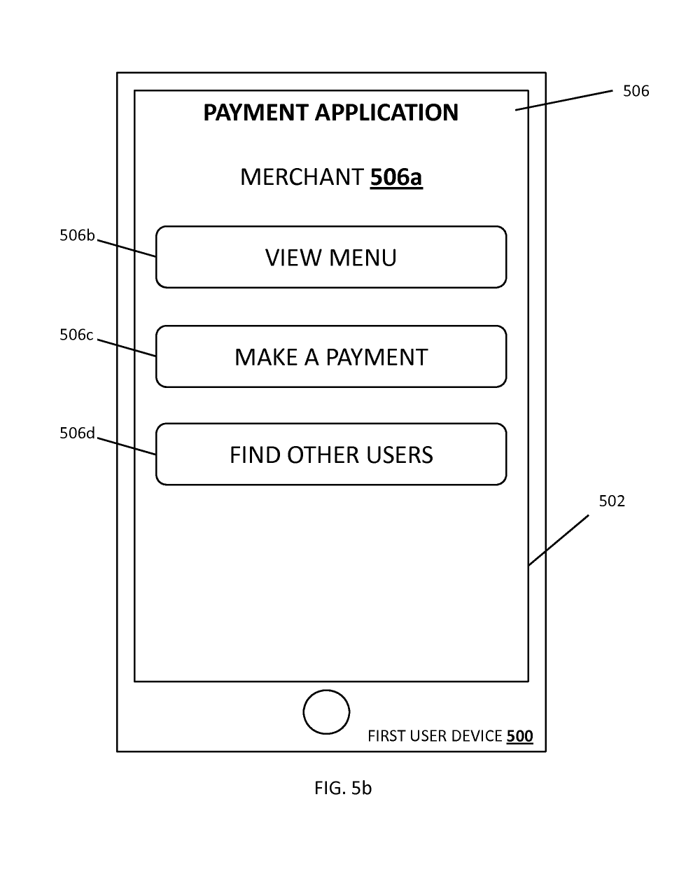

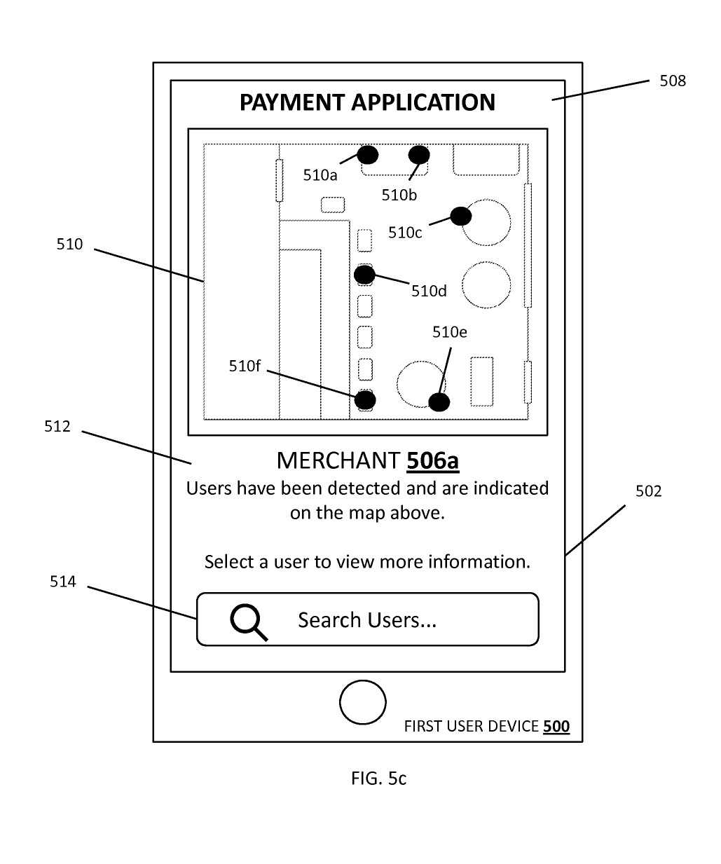

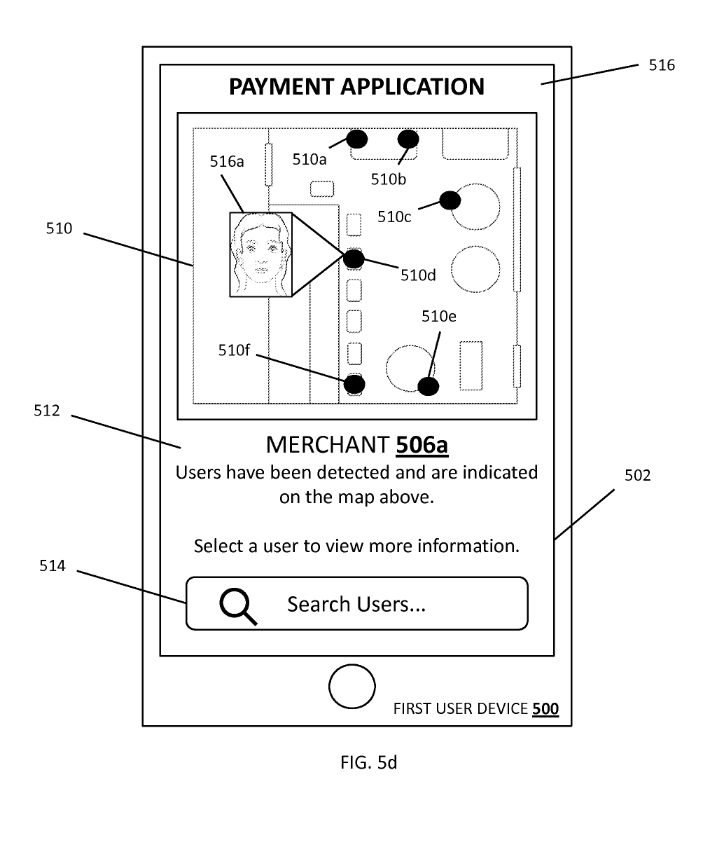

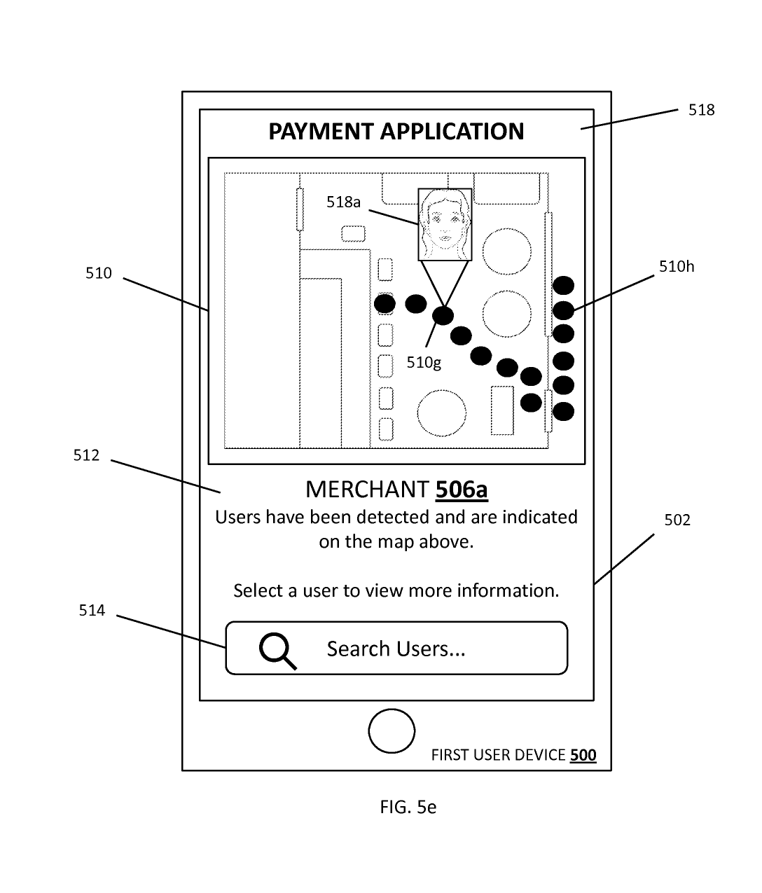

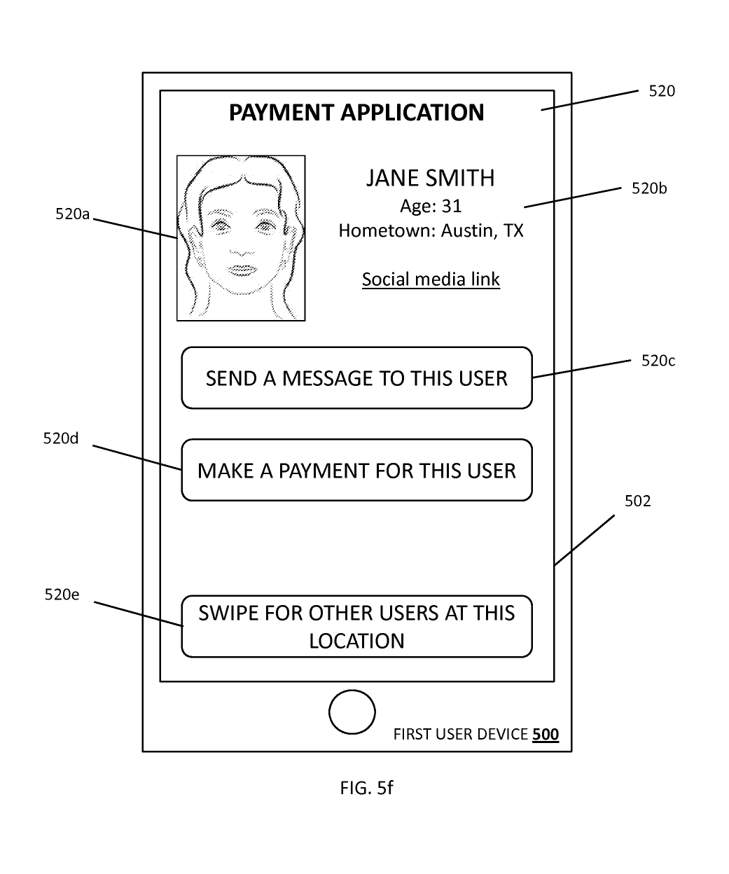

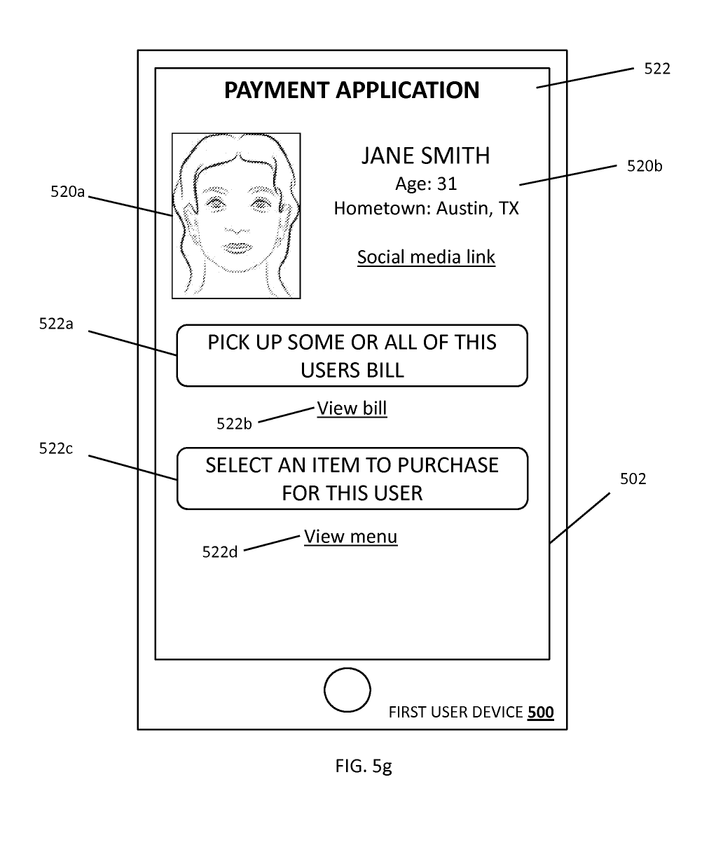

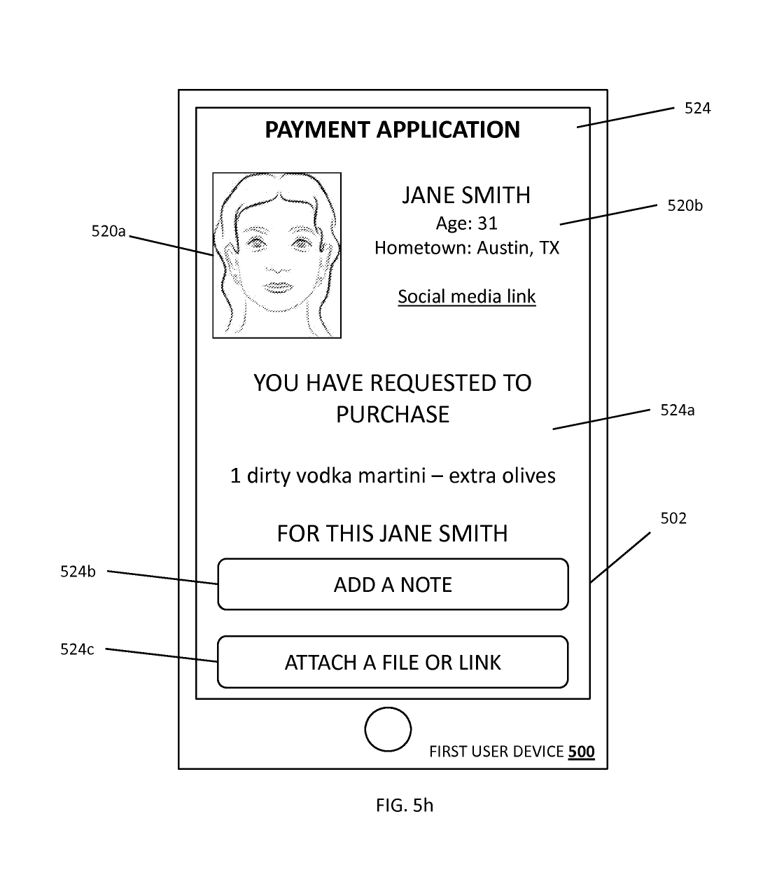

Referring now to FIG. 4, an embodiment of a method 400 for providing for the payment of a bill/item of a second user by a first user is illustrated that begins at block 402 where a find-users request that is directed to a physical merchant location is received from a first user. FIG. 5a illustrates an embodiment of a first user device 500 that includes a display 502 displaying a physical merchant location provisioning screen 504. In the embodiments discussed below, the first user device 500 is operated by a first user that wishes to pick up, cover, or otherwise pay for one or more items for a second user. While the first user device 500 is illustrated and described as a mobile phone or other computing device, other user devices will fall within the scope of the present disclosure. In the illustrated embodiments, the first user device 500 includes a payment application that operates to provide the functionality of the first user device 500 discussed herein, but the first user device 500 may utilize a variety of systems such as, for example, web interfaces to provide the functionality described herein, while remaining within the scope of the present disclosure. The payment application, web interface, or other user interface may be provided by a payment service provider (e.g., PayPal, Inc. of San Jose, Calif.) that provides payment services for the users and merchants discussed below by allowing those users and merchants to link payment accounts (provided by account providers, the payment service provider, etc.) to a payment service account, and then transferring payments between user payment accounts and merchant payment accounts for purchases. However, the bill/item payment-for-another system may be provided by account providers, merchants, or other system providers (referred to as “system providers” below) known in the art while remaining within the scope of the present disclosure. In the illustrated embodiment, the physical merchant location provisioning screen 504 may be provided by the payment application on the first user device 500 in response to the user launching the payment application.

In an embodiment, the physical merchant location provisioning screen 504 provided by the payment application on the first user device 500 provides the first user the ability to specify a physical merchant location utilizing a search input box 504a and/or a plurality of merchant identifiers 504b, 504c, 504d, 504e, and 504f. For example, the first user device 500 may include a location determination device such as, for example, a GPS device that operates to determine a current location of the user device 500 and provide that current location over a network to the system provider device. The system provider device may then operate to retrieve each of the merchant identifiers 504b, 504c, 504d, 504e, and 504f by determining physical merchant locations that are within a predetermined distance from the current location of the first user device 500, and provide the merchant identifiers 504b-f for display on the first user device 500. In other embodiments, the first user device 500 may be located at the physical merchant location 100, and the beacon system 300 may communicate with the first user device 500 and provide the location of the first user device 500 to the system provider device. As discussed below, the bill/item payment-for-another system may be utilized by first user devices (e.g., the first user device 500) when they are located at the physical merchant location 100, or when the first user devices are remote from the physical merchant location 100 (e.g., at their home or other location that is different from the physical merchant location 100) while remaining within the scope of the present disclosure. In embodiments where the first user device 500 is located at the physical merchant location 100, the physical merchant location provisioning screen 504 may be skipped and the first user device 500 may instead display a physical merchant location action screen for the physical merchant location 100, discussed below, based on the detection of the first user device 500 at the physical merchant location 100.

Thus, in some embodiments of block 402, the user of the first user device 500 may provide an identification of a merchant or physical merchant location (e.g., using the search input box 504a), a selection of a detected merchant or physical merchant location (e.g., by selecting one of the merchant identifiers 504b-f on the physical merchant location provisioning screen 504), or the first user device 500 may be detected at the physical merchant location 100 in order to send the system provider device the find-users request directed to the physical merchant location. While a few examples have been provided, one of skill in the art in possession of the present disclosure will recognize that a merchant and/or physical merchant location may be designated and/or provided to a system provider device in a wide variety of manners while remaining within the scope of the present disclosure.

Referring now to FIG. 5b, in response to sending the find-users request that includes an identification of the merchant or physical merchant location, the first user device 500 may display a physical merchant location action screen 506 (e.g., using information received from the system provider device over the network in response to the find-users request). The physical merchant location action screen 506 includes a merchant identification 506a that identifies the merchant and/or physical merchant location designated by the first user as discussed above, along with a view menu button 506b, a make a payment button 506c, and a find-users button 506d. In the illustrated embodiment, the physical merchant location action screen 506 is provided for a restaurant/bar, and the view menu button 506b may be selected by the first user to access a menu provided by the merchant 506a, the make a payment button 506c may be selected by the first user to pay for a purchase for the first user from the merchant 506a, and the find-users button 506d may be selected by the first user to send an instruction to the system provider device to find second users at a physical merchant location 100 of the merchant 506a, discussed in further detail below.

In some embodiments, at block 402 the first user may select the find-users button 506d to send an instruction to the system provider device to find second users at the physical merchant location 100 of the merchant 506a. However, as discussed below, in some embodiments, the first user device 500 may be automatically detected at the physical merchant location 100 of the merchant 506a, and in some examples of those embodiments, the find-users request may be automatically (e.g., without instructions from the first user on the first user device 500) sent to the system provider device.

The method 400 then proceeds to block 404 where second users that are located at the physical merchant location are determined. In an embodiment, in response to receiving the find-users request at block 402, the system provider device operates to determine second users that are located at the physical merchant location 100. In some examples, the beacon system 300 at the physical merchant location 100 may communicate as discussed above with any second user devices in the physical merchant location 100, and at block 404 the system provider device may receive identifiers for each of those second user devices at the physical merchant location 100 from the beacon system 300. In other examples, second users participating in the bill/item payment-for-another system may “check-in” to the bill/item payment-for-another system using check-in applications such as, for example, the Foursquare® application available from Foursquare® Labs, Inc. of New York City, N.Y., and the system provider device may retrieve identities of second user devices that have recently checked in to the physical merchant location 100 (e.g., within a predetermined time period, without checking into a subsequent location, etc.). In yet another example, the payment application provided by the system provider on second user devices may communicate the location of its second user device directly to the system provider device, and thus the system provider device may access a user database that updates the locations of second user devices using the payment application to retrieve the identities of second user devices that are currently located at the physical merchant location 100. While a few examples have been provided, one of skill in the art will recognize that the system provider device may determine that second user devices are located at the physical merchant location 100 in a wide variety of manners while remaining within the scope of the present disclosure.

In some embodiments, the second users determined to be located at the physical merchant location 100 may be restricted to second users that have some connection to the first user. For example, the system provider device may retrieve information about second users from the first user such as, for example, second users that are connected to the first user through a social network, second users that are included as contacts of the first user in the first user device 500, second users that have recently communicated with the first user (e.g., via email applications, text applications, chat applications, etc., within a predetermined time period), and/or via other connection characteristics known in the art. As such, the second users determined to be located at the physical merchant location 100 may be a subset of second users that are actually located at the physical merchant location 100 and that have been filtered by having some connection to the first user. In other embodiments, second users determined to be located at the physical merchant location 100 may be restricted to second users having a second user device that includes a payment application provided by the system provider or payment service provider (e.g., that is also used on the first user device 500 to perform the actions discussed above with regard to the method 400).

The method 400 then proceeds to block 406 where second user information for each second user is retrieved. In an embodiment, the system provider device may use the identities of the second user devices (e.g., phone numbers or other identifiers) that were determined to be located at the physical merchant location 100 at block 404 to retrieve the respective second user account information. For example, each second user participating in the bill/item payment-for-another system may have a user account with the system provider that is associated with user account information in a user database and that is accessible by the system provider device. Such user account information may be provided by the second users when activating the payment application on their second user devices, and may include a user name, a user address, an image of the user, links to social media pages of the user, user payment account information, and/or a variety of other user account information known in the art. In another example, the second user information may be retrieved directly from the second user devices that were determined to be located at the physical merchant location 100 at block 404. As such, the second users of the second user devices may make their second user information accessible by the system provider device for retrieval at block 406, and that second user information may include any or all of user names, user addresses, images of users, links to social media pages of users, user payment account information, and/or other information discussed above. Thus, following bock 406, the system provider device has detected one or more second user devices at the physical merchant location 100 and retrieved respective second user information associated with those one or more second user devices.

Referring now to FIGS. 5c, 5d, and 5e, the method 500 may proceed to block 408 where the second user information for the second users is provided for display to the first user. In an embodiment, the system provider device may provide at least some of the second user information retrieved at block 406 over the network for display on the first user device 500. FIG. 5c illustrates the first user device 500 displaying a user detection screen 508 that includes a physical merchant location map 510, a user selection instruction 512, and a user search input 514. In an embodiment, the physical merchant location map 510 may be retrieved by the system provider device from merchant information that is associated with the merchant 506a and/or the physical merchant location 100 in a merchant database that is accessible by the system provider device. In the illustrated embodiment, the second user information provided for display on the first user device 500 at block 408 includes second user device location information provided on the physical merchant location map 510 such as, for example, the second user indicators 510a, 510b, 510c, 510d, 510e, and 510f. For example, the system provider device may utilize the physical merchant location map 510 and location information retrieved from each of the second user devices 406 to determine the relative locations of each of the second user devices in the physical merchant location 100, and provide those relative locations as the second user indicators 510a, 510b, 510c, 510d, 510e, and 510f, as illustrated. The user selection instruction 512 informs the first user that the second users have been detected and are associated with the second user indicators 510a-f, and that the first user may select any second user indicator 510a-f to retrieve more information about a particular second user. The user search input 514 allows the first user to input user search information about a desired second user and have that user search information provided to the system provider device for a determination of whether any of the second users associated with the second user indicators 510a-f are identified by that user search information.

FIG. 5d illustrates the first user device 500 displaying a user information preview screen 516 that includes the physical merchant location map 510 with second user indicators 510a-f, the user selection instruction 512, and the user search input 514. In an embodiment, the user information preview screen 516 may be provided in response to the first user designating a second user for whom they would like more information. For example, the first user may have selected the second user indicator 510d (e.g., by providing a touch input on the display 502 at the location where the second user indicator 510d is displayed) and, in response, a second user image 516a (which may have been retrieved at block 406 as part of the second user information) is displayed over the physical merchant location map 510 and extending from the second user indicator 510d, as illustrated. In another example, the first user may have provided user search information in the user search input 514 and, in response, the system provider device may have determined that user search information identified the second user associated with the second user indicator 510d and retrieved and displayed the second user image 516a over the physical merchant location map 510 and extending from the second user indicator 510d, as illustrated.

In a specific example of the embodiments illustrated in FIGS. 5c and 5d, the first user may be located at the physical merchant location 100, and may wish to pick up, cover, or otherwise pay for one or more items on a bill of a second user at the physical merchant location 100 that they do not know. Thus, some examples of the embodiments illustrated in FIGS. 5c and 5d allow the first user to see a second user that they do not know at the physical merchant location 100 and use the user detection screen 508 and user information preview screen 516 as discussed above to find that second user (via the user image 516a provided as discussed above). In other examples, the first user may be remote from the physical merchant location 100, and may wish to pick up, cover, or otherwise pay for one or more items or a bill of a second user at the physical merchant location 100 that they know. Thus, some examples of the embodiments illustrated in FIGS. 5c and 5d allow the first user to identify a second user that they know at the physical merchant location 100 and use the user detection screen 508 and user information preview screen 516 as discussed above to find that second user (via the user image 516a provided as discussed above). However, further embodiments may allow a first user that is located at the physical merchant location 100 to find a second user that they know at the physical merchant location 100, or allow a first user that is remote from the physical merchant location 100 to find a second user that they do not know at the physical merchant location 100.

FIG. 5e illustrates the first user device 500 displaying a user information preview screen 518 that includes the physical merchant location map 510, the user selection instruction 512, and the user search input 514. In the illustrated embodiment, the physical merchant location map 510 includes a plurality of second user indicators (similar to the second user indicators 510a-f discussed above) that include a second user indicator 510g. In addition, a first user indicator 510h that indicates the relative position of the first user device 500 and the physical merchant location 100 is provided by the system provider device using location information associated with the first user device 500 similarly as discussed above. The embodiments illustrated in FIG. 5e provide a situation in which users at the physical merchant location 100 are lined up to make purchases from the merchant 506a, with the second user associated with the second user indicator 510g located near the front of the line and the first user using the first user device 500 and associated with the first user indicator 510h located near the end of the line.

In an embodiment, the user information preview screen 518 may be provided in response to the first user designating a second user for whom they would like more information. For example, the first user may have selected the second user indicator 510g (e.g., by providing a touch input on the display 502 coinciding with the second user indicator 510g) and, in response, a second user image 518a (which may have been retrieved at block 406 as part of the second user information) is displayed over the physical merchant location map 510 and extending from the second user indicator 510g, as illustrated. In another example, the first user may have provided user search information in the user search input 514 and, in response, the system provider device may determine that that user search information identifies the second user associated with the second user indicator 510g and retrieve and display the second user image 518a over the physical merchant location map 510 and extending from the second user indicator 510g, as illustrated.

In a specific example of the embodiments illustrated in FIG. 5e, the first user is in line at the physical merchant location 100, and may wish to pick up, cover, or otherwise pay for one or more items or a bill of a second user that is in line at the physical merchant location 100 as well. Thus, some examples of the embodiments illustrated in FIG. 5e allow the first user to see a second user in line that they may or may not know at the physical merchant location 100 and use the user detection screen 508 and user information preview screen 518 as discussed above to find that second user (via the user image 518a provided as discussed above). However, other embodiments may allow a first user that is remote from the physical merchant location 100 to find a second user that they do not know in line at the physical merchant location 100. While the above example has been directed to second users in line, second users may be seated at a table (e.g., one of the tables 112) and selectable by a first user (using their associated second user indicators) if, for example, the first user would like to pick up a bill for those second users.

While examples of second user information that includes second user locations and images has been discussed as being provided for display on the first user device at block 408, any other information available about the second users may be provided for display on the first user device 500 in a variety of manners while remaining within the scope of the present disclosure. For example, second user names, second user device identifiers (e.g., phone numbers), and/or other second user information may be provided for display on the first user device 500 in a list or other format that is different from the map format illustrated in FIGS. 5c-e. Furthermore, second users may define a privacy policy (e.g., via the payment application) that restricts what second user information may be provided for display to first users, which first users may be provided their second user information, and/or a variety of other privacy considerations known in the art. Thus, following block 408, the system provider device has provided second user information for the second user devices determined at block 404 to the first user device 500.

Referring now to FIG. 5f, the user device 500 is illustrated displaying a second user information screen 520. In an embodiment, the user device 500 may display the second user information screen 520 following the first user selecting a second user on the user detection screens 508 or user information preview screens 516 or 518 discussed above (e.g., selecting a second user indicator 510a-f, selecting the image 516a or 518a, selecting a second user identifier such as a second user name from a list, etc.). The second user information screen 520 includes a second user image 520a; second user information 520b including a second user name, a second user age, a second user hometown, and a link to a social media site of the second user; a send message button 520c; a make payment button 520d; and a find other users button 502e. While the second user information 520b is illustrated and described as including an image, name, age, hometown, and social media link for the second user selected by the first user, any second user information retrieved from the user database about the second user (and in some cases allowed by the second user based on permissions provided by the second user) may be displayed in the second user information screen 520 provided on the user device 500. The send message button 520c may be selected by the first user in order to provide a message (e.g., similar to a text message, an email message, a chat message, or message provided using other messaging systems known in the art) to the system provider device for delivery to a second user device associated with the second user in the user database. The make payment button 520d may be selected by the first user in order to provide an instruction to make a payment for an item for the second user, discussed in further detail below. The find other users button 502e may be selected by the first user in order to be provided a second user information screen (similar to the second user information screen 520) for different second users that were determined to be located at the merchant physical location 100 at block 404. As such, the find other users button 502e may allow the first user to “swipe” through second user information screens to view more detailed information about each of the second users (associated with the second user indicator 510a-f) at the physical merchant location 100.

Referring now to FIG. 5g, the user device 500 is illustrated displaying a bill/item payment-for-another screen 522. In an embodiment, the user device 500 may display the bill/item payment-for-another screen 522 following the first user selecting the make payment button 520d on the second user information screen 520 discussed above. The bill/item payment-for-another screen 522 includes the second user image 520a and the second user information 520b discussed above. In addition, the bill/item payment-for-another screen 522 includes a previously selected items purchase button 522a and an associated view bill link 522b, as well as a select item for purchase button 522c and an associated view menu link 522d.

In an embodiment, the first user may select the previously selected items purchase button 522a in order to start a request to the system provider device to make a purchase for an item that was ordered or otherwise previously selected by the second user. In response to receiving a selection of the previously selected items purchase button 522a, the system provider device may retrieve a bill that is associated with the second user and the merchant (e.g., from the merchant database) and provide the items on that bill for display on the first user device 500. In response to viewing the bill, the first user may select one or more items on the bill to purchase for the second user. Graphical user interfaces (not illustrated) may be utilized to allow the first user to quickly and easily select one or more items on the bill of the second user in order to provide an instruction to purchase those items for the second user. In addition, options may be provided to allow the first user to provide an instruction to pay for the entire bill of the second user. In some embodiments, the first user may select the associated view bill link 522b to have the system provider device retrieve a bill that is associated with the second user and the merchant (e.g., from the merchant database) and provide that bill for display on the first user device 500 such that the first user may determine whether they wish to pay for one or more items on that bill (or the entire bill). In an embodiment, the second user may provide permissions that define which items on a bill may be displayed to first users and, as such, any items from a bill that are provided for display on the first user device 500 by the system provider device may be filtered using those permissions such that items that the second user desires not to be displayed to first users are not displayed.

In an embodiment, the first user may select the select item for purchase button 522c in order to order to start a request to the system provider device to make a purchase for an item that is selected by the first user. In response to receiving a selection of the select item for purchase button 522c, the system provider device may provide an ordering screen for designating one or more items for purchase by the first user for the second user. In response to viewing the ordering screen, the first user may identify one or more items to purchase for the second user using the ordering screen. Graphical user interfaces (not illustrated) may be utilized to allow the first user to quickly and easily select one or more items on a menu of the merchant in order to provide an instruction to select and purchase those items for the second user. In some embodiments, the first user may select the associated view menu link 522d to have the system provider device retrieve a menu that is associated with the merchant (e.g., from the merchant database) and provide that menu for display on the first user device 500 such that the first user may determine whether they wish to select one or more items on that menu for the second user. In other embodiments, the first user device 500 may display a text input box that the first user may use to input an item or items that the first user would like to purchase for the second user. In an embodiment, the second user may provide permissions that define which items may be purchase for them by first users and, as such, any items designated for purchase by the first user for the second user may be filtered using those permissions such that items that the second user desires not to be purchased for them by first users are not displayed or allowed to be input.

In different embodiments, the first user may provide different purchase request details or rules along with the items selected for purchase for the second user. For example, the first user may provide a time restriction for the purchase request that may require that the second user accept the purchase request (discussed below) or that the items selected for the second user otherwise be purchased within a predetermined time period. In another example, the first user may provide an amount restriction for the purchase request that may limit an amount of a purchase covered by the purchase request (e.g., the first user may offer to buy a drink for the second user that the second user may select, but the amount of the drink that the second user may select must be below a predetermined amount according to the amount restriction). In some embodiments, the time restrictions, amount restrictions, and/or other restrictions may be implemented by the system provider as default restrictions on a purchase request. For example, any purchase request received from a first user may be required to be accepted and/or executed within 1 hour without any instruction by the first user.

In some embodiments, the first user may need to be preauthorized by the second user in order for the first user to make a purchase for the second user as discussed herein. For example, the second user may use the payment application on their second user device to retrieve and display each of the possible first users at the physical merchant location 100, similarly as discussed above with reference to blocks 402, 404, 406, and 408. The second user may then review first user information for possible first users that is displayed on the second user device in order to select the possible first users that they would like to authorize to make purchases for them. For example, the second user may review first user information for possible first users similarly as described above with reference to FIGS. 5d, 5e, and 5f. Using the specific example of FIG. 5f, this may allow the second users to view a first user image and first user details of a possible first user, select an authorize button if they would like that possible first user to be able to make a purchase of an item for them, and swipe through to any other possible first users in the physical merchant location 100 in order to perform similar actions. The authorization information received from the second user by the system provider device may then be checked against first users that attempt to make a purchase items for that second user (e.g., as discussed above with reference to FIG. 5g) to determine whether to allow the first user to make a purchase request for the second user.

In some embodiments, the system provider device may access the user database to determine previous purchases made by the second user in order to determine recommended purchases for that second user. For example, upon receiving a purchase request from the first user to purchase an item for the second user, the system provider device may review the user database to determine the drink most commonly purchased by the second user (on that visit and/or a plurality of previous visits), and provide that drink as a recommended drink for the second user to the first user. Similarly, any other regular purchase types by the second user may be suggested to the first user. In another embodiment, the system provider device may review the current bill of the second user and recommend complementary items for purchase by the first user. For example, a current bill of the second user may include an appetizer, an entrée, and drinks, and the system provider device may review that current bill to determine and recommend to the first user the purchase of a desert for the second user.

Referring now to FIG. 5h, the user device 500 is illustrated displaying a bill/item payment-for-another confirmation screen 524. In an embodiment, the user device 500 may display the bill/item payment-for-another confirmation screen 524 in response to the first user selecting one or more items from a bill of the second user, identifying one or more items (e.g., from a menu) to purchase for the second user, and/or otherwise providing an instruction to the system provider device to pay for items for the second user. The bill/item payment-for-another confirmation screen 524 includes the second user image 520a and the second user information 520b discussed above. In addition, bill/item payment-for-another confirmation screen 524 includes a confirmation message 524a that confirms with the first user the item(s) that they are requesting to purchase for the second user. While in the illustrated embodiment, the confirmation message 524a confirms the purchase of a single item (a drink), the confirmation message 524a may attempt to confirm any items or an entire bill that the first user has requested to purchase for the second user. The bill/item payment-for-another confirmation screen 524 also includes an add a note button 524b that the first user may select in order to be provided a note input (not illustrated) that allows the first user to add a note to the second user as part of a purchase request, and an attach file or link button 524c that the user may select to be provided a file/link input (not illustrated) that allows the first user to add a file or link for the second user as part of a purchase request.

The method 400 then proceeds to block 410 where a purchase request is received from the first user for at least one item for the second user. In an embodiment, the purchase request may be sent from the first user device 500 over the network to the system provider device in response to the first user providing a note to the second user as discussed above using the add a note button 524b, in response to the first user providing a file or link for the second user as discussed above using the attach file or link button 524c, after the bill/item payment-for-another confirmation screen 524 has been displayed on the first user device 500 for a predetermined amount of time, in response to the user selecting a confirmation button (not illustrated) on the bill/item payment-for-another confirmation screen 524, and/or in response to a variety of other confirmation actions known in the art.

The method 400 may then proceed to block 412 where a purchase request confirmation/authorization is received. The purchase request confirmation/authorization may be received in a wide variety of manners, examples of a few of which are provided below and include a purchase request confirmation/authorization from the merchant, from the second user, from the first user, and/or combinations thereof. Depending on the item or items being purchased, the manner in which they are selected and purchased, and/or a variety of other factors, purchase request confirmations/authorizations may be required, while in some situations the purchase request confirmation/authorization may not be required and block 412 may be skipped.

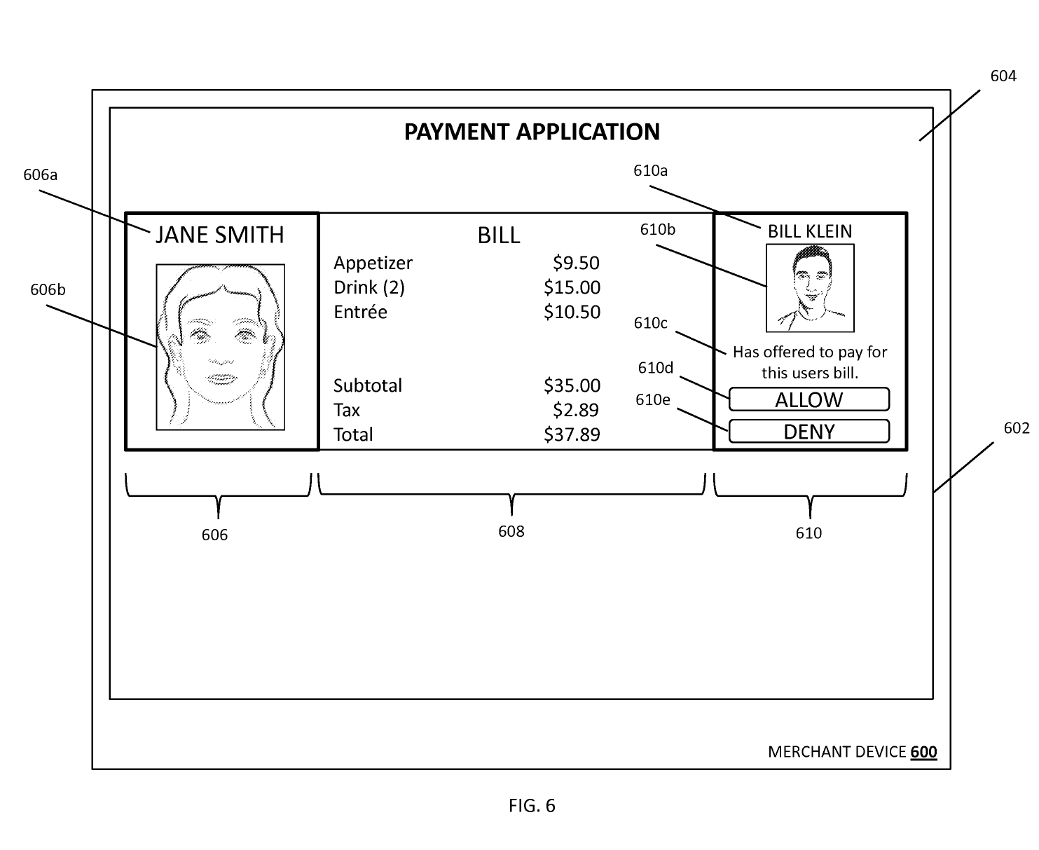

Referring now to FIG. 6, an embodiment of a merchant device 600 is illustrated that includes a display 602 displaying a bill/item payment-for-another authorization screen 604. In an embodiment, the system provider device may communicate with the merchant device 600 over the network to enable the provisioning of a bill/item payment-for-another authorization screen 604 on the merchant device 600 following receipt of the purchase request from the first user device discussed above. The a bill/item payment-for-another authorization screen 604 includes a second user identification section 606, a second user bill section 608, and a first user section 610. The second user identification section 606 includes a name 606a of the second user as well as an image 606b of the second user that may have been retrieved from the second user device from the merchant device 600 and/or the system provider device. The second user bill section 608 includes details of a bill the second user has with the merchant such as, for example, a plurality of items purchased by the second user (which may have been input to the merchant device 600 by the merchant), as well as a subtotal, tax, and total amount owed for the bill. The first user section 610 includes a name 610a of the first user, an image 610b of the first user, a purchase request information section 610c that describes the purchase the first user would like to make for the second user, an allow button 610d, and a deny button 610e. In the illustrated embodiment, the purchase request information section 610c indicates that the first user would like to pay for the entire amount of the bill (e.g., the total in the second user bill section 608). However, in other embodiments, the purchase request information section 610c may indicate any particular items the first user would like to purchase for the second user (e.g., the drink discussed above with reference to FIG. 5h).

In some examples, the payment application on the merchant device 600 displaying the a bill/item payment-for-another authorization screen 604 may be a bill generating payment application used by the merchant to track orders and bills for customers, and that bill generating payment application may communicate with the system provider device as discussed above to receive and display the information in the first user section 610. In some embodiments, the a bill/item payment-for-another authorization screen 604 allows a merchant to be informed that the first user would like to purchase one or more items for a second user, inform the second user of the purchase request, request an authorization from the second user, and select the allow button 610d or the deny button 610e depending on the response from the second user. In some embodiments, the second user section 610 may not include the allow button 610d or the deny button 610e, but rather may simply inform the merchant that the first user is purchasing one or more items for the second user, and in response the merchant may provide those items to the second user. As such, in some embodiments, the bill/item payment-for-another authorization screen 604 may be the only purchase request authorization screen provided by the system provider device. However, in other embodiments, the bill/item payment-for-another authorization screen 604 may be provided along with the other purchase request confirmation/authorization screens discussed below. In response to the second user verbally accepting the offer by the first user, the merchant may select the allow button 610d and a purchase request authorization may be sent from the merchant device 600 to the system provider device over the network.

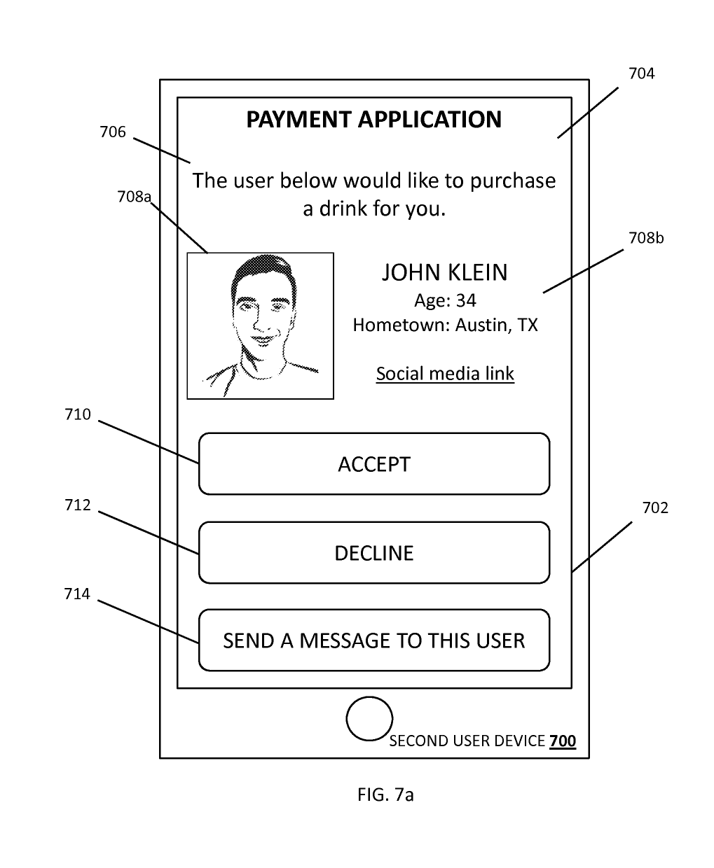

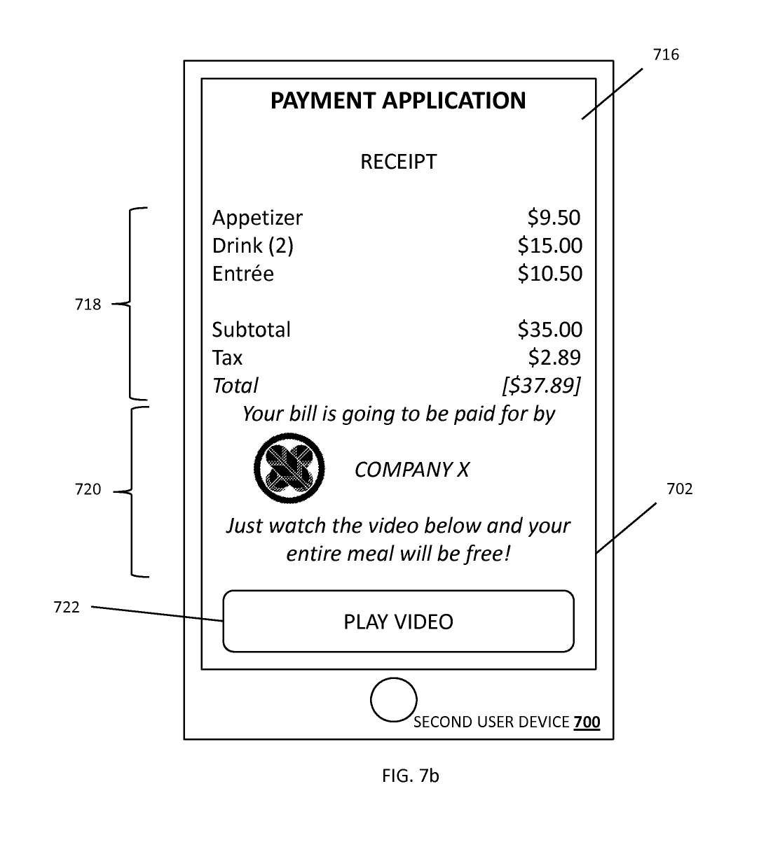

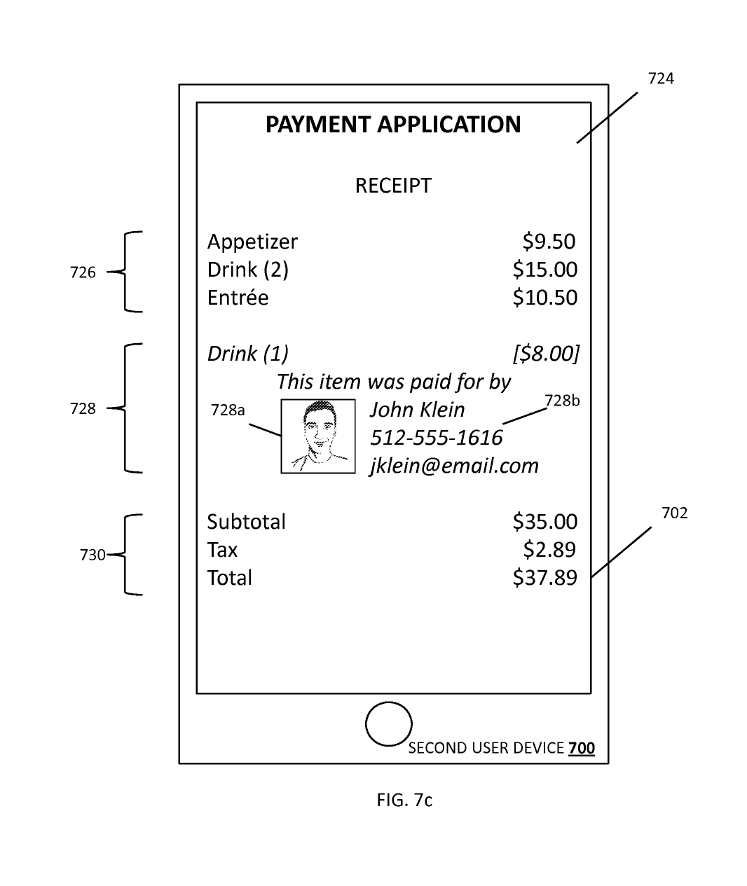

Referring now to FIG. 7a, an embodiment of a second user device 700 is illustrated that includes a display 702 displaying a bill/item payment-for-another authorization screen 704. In an embodiment, the system provider device may communicate with the second user device 700 over the network to enable the provision of the bill/item payment-for-another authorization screen 704 on the second user device 700 following receipt of the purchase request from the first user device discussed above. The bill/item payment-for-another authorization screen 704 includes a purchase request information section 706 describing the item or items that the first user would like to purchase for the second user, a first user image 708a and first user information 708b that includes a first user name, a first user age, a first user hometown, and a link to a social media page of the first user. The bill/item payment-for-another authorization screen 704 also includes an accept button 710 that the second user may select to accept the purchase of the item or items by the first user, a decline button 712 that the second user may select to decline the purchase of the item or items by the first user, and a send message button 714 that the second user may select to be provided a message input that allows the second user to send a message to the first user over the network through the system provider device.

In some examples, the bill/item payment-for-another authorization screen 704 allows the second user to be informed that the first user would like to purchase one or more items for them, determine whether to accept or decline that request, and/or send a message to the first user. In some embodiments, the bill/item payment-for-another authorization screen 704 may not include the accept button 710 or the decline button 712, but rather may simply inform the second user that the first user has purchased one or more items for them. The second user may select the accept button 710 in order to have the system provider device notify the merchant of the purchase request from the first user and, in response, the merchant may provide those items to the second user. As such, in some embodiments, the bill/item payment-for-another authorization screen 704 may be the only purchase request authorization screen provided by the system provider device. However, in other embodiments, the bill/item payment-for-another authorization screen 704 may be provided along with the other purchase request confirmation/authorization screens discussed herein. In response to the second user selecting the accept button 710, a purchase request authorization may be sent from the second user device 700 to the system provider device over the network.

Referring now to FIG. 7b, an embodiment of the second device 700 is illustrated that includes the display 702 displaying a bill receipt screen 716. In an embodiment, the system provider device may communicate with the second user device 700 over the network to enable the provision of the bill receipt screen 716 on the second user device 700 according to a purchase request from a first user. In this embodiment, the purchase request comes from a first user that is a company that is paying for the bill of the second user in exchange for viewing an advertisement. The bill receipt screen 716 includes a bill details section 718 detailing the items selected by the second user, a purchase request information section 720 that informs the second user of the identity of the first user/company that is making the purchase request along with an instruction to watch a video in order to authorize the purchase request and have their bill paid for, and a video link 722 that may be selected by the second user to watch the video provided by the first user/company.

In some examples, the bill receipt screen 716 allows a first user to make a purchase request to purchase one or more items for a second user that is contingent on the second user performing some action such as, for example, viewing the video as discussed above, opening a file, accessing a webpage via a link, and/or a variety of other actions known in the art. The second user may select the play video link 722 in order to launch a video player that plays the video (which may have been provided to the second user device 700 from the system provider device), link the second user device 700 to a webpage that provides the video, and/or otherwise provide access through the second user device 700 to the video. In some embodiments, the progress of the video may be monitored to ensure that the second user has completed watching the video (or at least some minimal amount of the video) and, in response, a purchase request authorization may be sent from the second user device 700 to the system provider device over the network. As such, a first user (a company in this example) that is remote from the physical merchant location 100 may make purchase requests to pay for item(s) purchased by second users at the physical merchant location 100 that are contingent on those second users performing an action desired by the first user, and the performance of that action is monitored such that a purchase request confirmation will be sent upon the completion of that action by the second user.

The method 400 then proceeds to block 414 where a payment amount is transferred from the first user to the merchant for the at least one item. In an embodiment, in response to receiving the purchase request confirmation/authorization at block 412, the system provider device operates to transfer a payment amount for the one or more items purchased by the first user for the second user from a first user payment account of the first user to a merchant payment account of the merchant. In addition, at block 414 the system provider device may inform the merchant, the first user, and/or the second user of the transfer (or impending transfer) of the payment amount from the first user payment account to the merchant payment account. For example, the system provider device may communicate over the network to the merchant device to inform the merchant device that the payment amount is being (or will be) transferred from the first user payment account to the merchant account and, in response, the merchant may provide the items purchased by the first user to the second user at the physical merchant location 100.

In some embodiments, other conditions may be attached to having a purchase request confirmed such that items for the second user are paid for by the first user. For example, the second user may be required to pay for their remaining items using the payment application on the second user device, discussed above, in order to have the items designated by the first user paid for using the first user payment account. However, in other embodiments, the payment of the items by the first user may be made using the payment application and first user payment account, and the second user may pay for any additional items using any payment methods they wish.

Referring to FIG. 7c, an embodiment of the second device 700 is illustrated that includes the display 702 displaying a bill receipt screen 724. In an embodiment, the bill receipt screen 724 may be provided to second user device 700 over the network from the system provider device and/or the merchant device following the transfer of the payment amount from the first user payment account and the merchant payment account. The bill receipt screen 724 includes a first bill sub-portion 726 that includes items purchased and paid for by the second user, a second bill sub-portion 728 that includes items purchased and paid for by the first user, and a third bill sub-portion 730 that includes the subtotal, tax, and total for the bill for the second user that does not include the amount that was paid for by the first user and that is detailed in the second bill sub-portion 728. The second bill sub-portion 728 includes information about the item(s) purchased by the first user for the second user, a first user image 728a of the first user, and first user information 728b that, in the illustrated embodiment, in includes a first user name, a first user phone number, and a first user email address that may have been retrieved from the user database by the system provider device.

Thus, a bill receipt screen may be provided on the second user device 700 to inform the second user of the purchases on their bill that have been made by the first user. While illustrated as being electronically displayed on the second user device 700, the information included on the bill receipt screen 724 may be provided in a paper bill printed out and provided by the merchant to the second user while remaining within the scope of the present disclosure. However, electronic provision of the bill receipt information in the bill receipt screen 724 provides the ability to offer beneficial features such as, for example, a file provided by the first user. For example, a first user may pay for the bill of the second user, and provide a file such as a word processing document file that includes a resume of the first user that is provided on the bill receipt screen 724 for viewing by the second user.

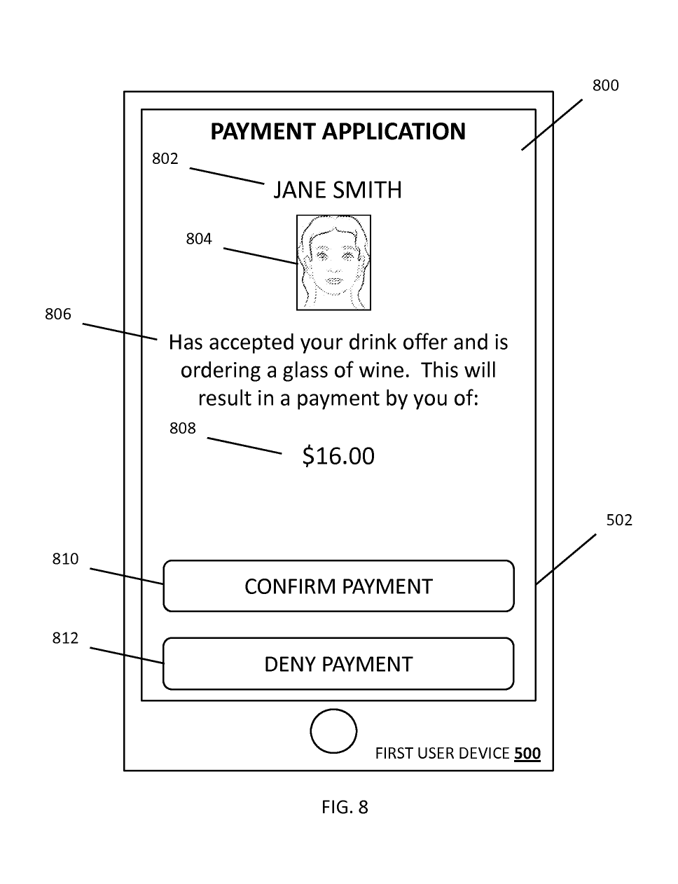

Referring now to FIG. 8, as discussed above, in some embodiments the first user may provide a payment request confirmation subsequent to sending the purchase request to the system provider device. In some embodiments, the first user may provide a purchase request that makes an offer to purchase an item or items that may be selected at a later time by the second user. For example, the first user may offer to purchase a drink for the second user that may be selected by the second user. Following the transmission of the purchase request from the first user device to the system provider device, the system provider device may forward that purchase request to the second user device substantially as discussed above. That purchase request may then be presented to the second user (by the merchant, via the second user device, etc.) and may allow the second user to provide a type of drink for purchase. In response to the second user selecting an item for purchase in response to the purchase request, the system provider device may provide a payment request confirmation screen over the network to the first user device.

FIG. 8 illustrates the first user device 500 including the display 502 displaying a payment request confirmation screen 800. The payment request confirmation screen 800 includes a second user name 802 of the second user, a second user image 804 of the second user, a purchase request information section 806 describing the purchase the second user has selected, and a price 808 of the selected purchase of the second user. The payment request confirmation screen 800 also includes a confirm payment button 810 and a deny payment button 812. The first user may review the purchase request information section 806 and the price 808 to determine whether to confirm (via the confirm payment button 810) or deny (via the deny payment button 812) the payment amount that will be transferred from the first user payment account to the merchant payment account. Thus, at block 412, a payment request confirmation may be sent from the first user device 500 to the system provider device in response to the first user selecting the confirm payment button 810. The purchase request may be cancelled by the merchant and/or the system provider in response to a purchase request cancellation request sent from the first user device 500 in response to the first user selecting the deny payment button 812.

In some embodiments, data generated by multiple performances of the method 400 may be compiled and analyzed to provide additional services for users. For example, the system provider device may analyze data of purchase requests provided by first users and accepted or denied by second users, along with details of bills and/or items covered by first users for second users, to determine physical merchant locations where purchase requests are more likely to be received and/or accepted. As such, recommendations and/or statistics may be made to users about physical merchant locations or geographic areas where purchase requests are more likely to be received and/or accepted.

Thus, systems and methods for providing for the payment of a bill of a second user by a first user have been described that allow a first user to quickly and easily determine second users at a physical merchant location, determine one or more items that were previously selected by a second user to pay for, select one or more items to purchase for the second user, and/or provide an instruction to a system provider to purchase those items for the second user. The systems and methods may provide for the second user and/or merchant to authorize such purchases, and may provide information that was received from the first user to the first user. The systems and methods described herein greatly simplify the ability of a user to pick up or cover some or all of a bill for another user, while enabling information sharing and other functionality described herein that traditional methods are lacking.

In an example of a user case of the systems and methods of the present disclosure, a first user may quickly and easily purchase items for a friend that the first user sees at a restaurant (e.g., in line in front of the first user, sitting at a different table from the first user, etc.) In another example, a first user may quickly and easily purchase items for a stranger at a bar. In yet another example, a company may pick up tabs at a restaurant or bar in exchange for actions performed by the users responsible for those tabs (e.g., viewing advertisements as discussed above.) Other features provided by the systems and methods in such examples may include the ability of the first user to specify the location and time during which those tabs will be picked up (e.g., Restaurant X between 8 pm and 10 pm on a Monday night). In yet another example, a first user may pick up a tab of a prospective employer and attach a resume to the bill receipt. While several examples have been provided, one of skill in the art in possession of the present disclosure will recognize how those examples may be combined and mixed to provide a variety of benefits in paying or bills or items for other users.

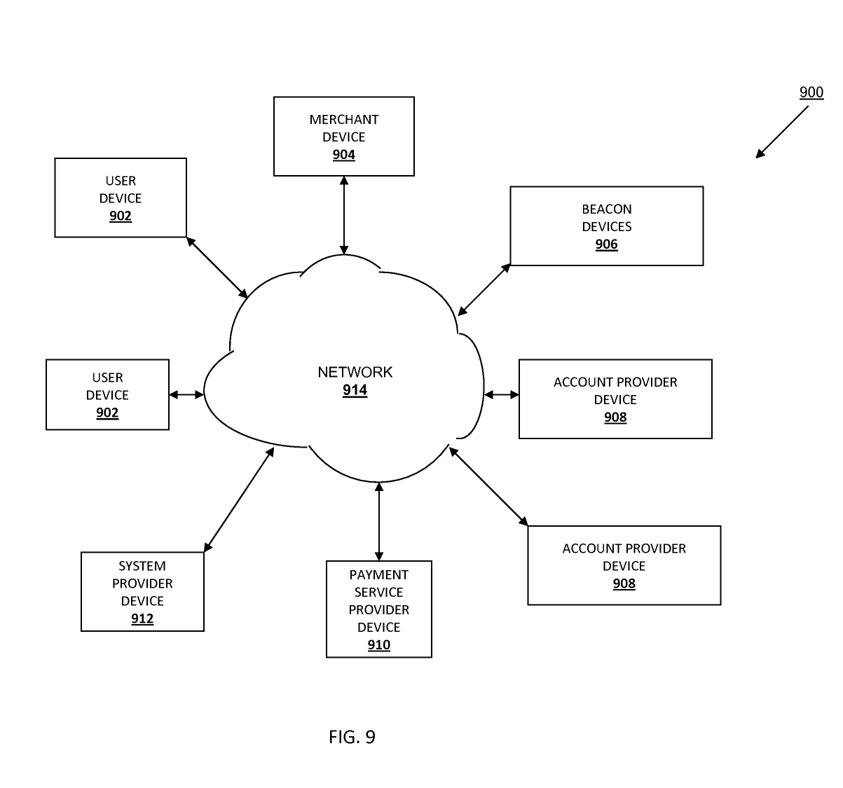

Referring now to FIG. 9, an embodiment of a network-based system 900 for implementing one or more processes described herein is illustrated. As shown, the network-based system 900 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 9 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 900 illustrated in FIG. 9 includes a plurality of user devices 902, a plurality of merchant devices 904, a plurality of beacon devices 906, a plurality of account provider devices 908, a payment service provider device 910, and/or a system provider device 912 in communication over one or more networks 914. The user devices 902 may be the user devices discussed above and may be operated by the users discussed above. The merchant devices 904 and beacon devices 906 may be the merchant devices and beacon devices discussed above and may be operated by the merchants discussed above as well as, in some embodiments, the system provider as well. The account provider device 908 may be the account provider devices discussed above and may be operated by the account providers discussed above which may include checking account providers, savings account providers, credit account providers, and/or a variety of other account providers known in the art. The payment service provider device 910 may be the payment service provider devices discussed above and may be operated by a payment service provider such as, for example, PayPal Inc. of San Jose, Calif. The system provider devices 912 may be the system provider devices discussed above and may be operated by the system providers discussed above.

The user devices 902, merchant devices 904, beacon devices 906, account provider devices 908, payment service provider device 910, and/or system provider device 912 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 900, and/or accessible over the network 914.

The network 914 may be implemented as a single network or a combination of multiple networks. For example, in various embodiments, the network 914 may include the Internet and/or one or more intranets, landline networks, wireless networks, and/or other appropriate types of networks.

The user devices 902 may be implemented using any appropriate combination of hardware and/or software configured for wired and/or wireless communication over network 914. For example, in one embodiment, the user devices 902 may be implemented as a personal computer of a user in communication with the Internet. In other embodiments, the user devices 902 may be a smart phone, personal digital assistant (PDA), laptop computer, and/or other types of computing devices.

The user devices 902 may include one or more browser applications which may be used, for example, to provide a convenient interface to permit the user to browse information available over the network 914. For example, in one embodiment, the browser application may be implemented as a web browser configured to view information available over the Internet.

The user devices 902 may also include one or more toolbar applications which may be used, for example, to provide user-side processing for performing desired tasks in response to operations selected by the user. In one embodiment, the toolbar application may display a user interface in connection with the browser application.

The user devices 902 may further include other applications as may be desired in particular embodiments to provide desired features to the user devices 902. In particular, the other applications may include a payment application for payments assisted by a payment service provider through the payment service provider device 910. The other applications may also include security applications for implementing customer-side security features, programmatic customer applications for interfacing with appropriate application programming interfaces (APIs) over the network 914, or other types of applications. Email and/or text applications may also be included, which allow user to send and receive emails and/or text messages through the network 914. The user devices 902 includes one or more user and/or device identifiers which may be implemented, for example, as operating system registry entries, cookies associated with the browser application, identifiers associated with hardware of the user devices 902, or other appropriate identifiers, such as a phone number. In one embodiment, the user identifier may be used by the payment service provider device 910 to associate the user with a particular account as further described herein.

The merchant devices 904 may be maintained, for example, by a conventional or on-line merchant, conventional or digital goods seller, individual seller, and/or application developer offering various products and/or services in exchange for payment to be received conventionally or over the network 914. In this regard, the merchant devices 904 may include a database identifying available products and/or services (e.g., collectively referred to as items) which may be made available for viewing and purchase by the user.

The merchant devices 904 also include a checkout application which may be configured to facilitate the purchase by the payer of items. The checkout application may be configured to accept payment information from the user through the user devices 902 and/or from the payment service provider through the payment service provider device 910 over the network 914.

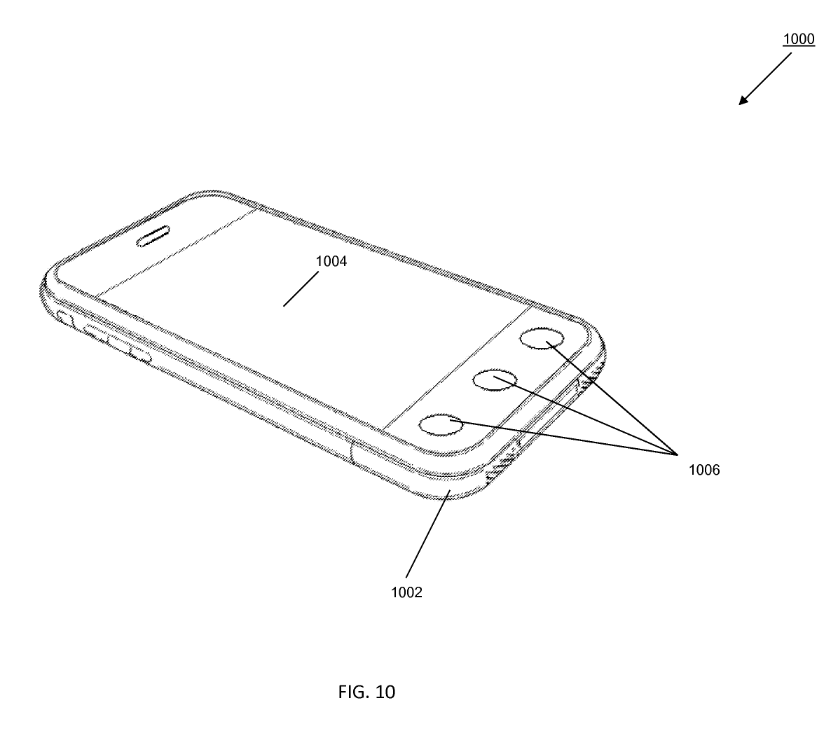

Referring now to FIG. 10 an embodiment of a user device 1000 is illustrated. The user device 1000 may be the user devices discussed above. The user device 1000 includes a chassis 1002 having a display 1004 and an input device including the display 1004 and a plurality of input buttons 1006. One of skill in the art will recognize that the user device 1000 is a portable or mobile phone including a touch screen input device and a plurality of input buttons that allow the functionality discussed above with reference to the methods above. However, a variety of other portable/mobile user devices and/or desktop user devices may be used in the methods discussed above without departing from the scope of the present disclosure.

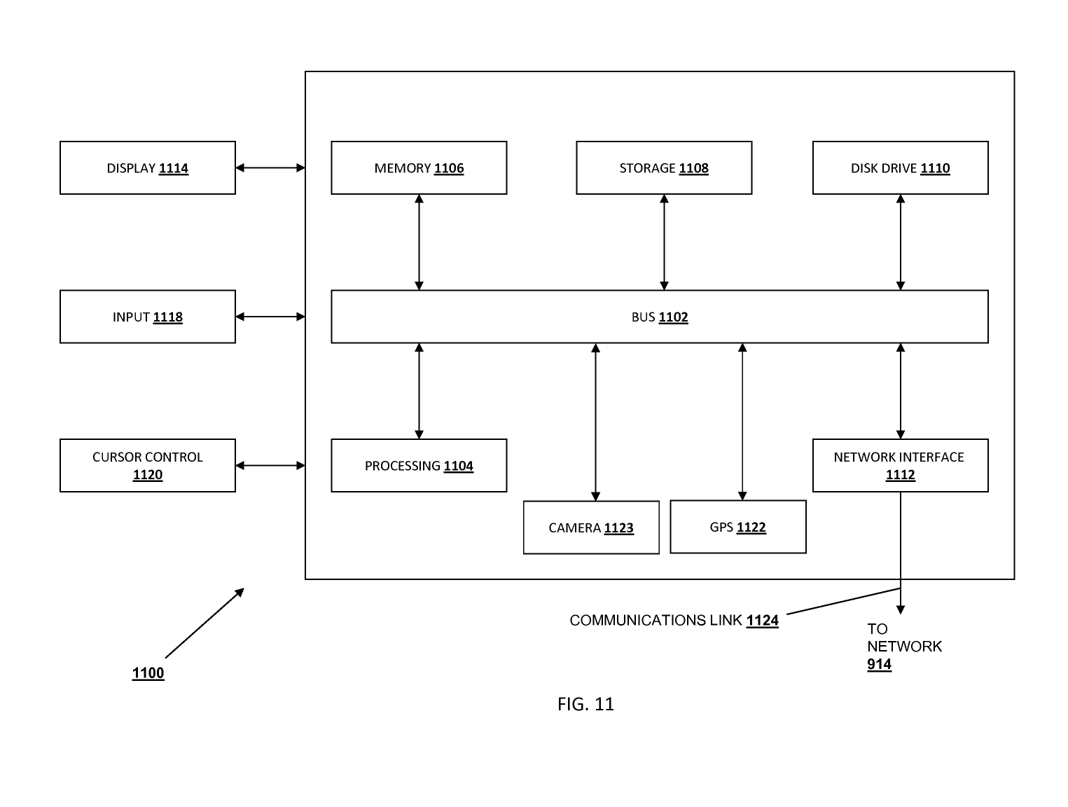

Referring now to FIG. 11, an embodiment of a computer system 1100 suitable for implementing, for example, the user devices, merchant devices, beacon devices, account provider devices, payment service provider device, and/or the system provider device, discussed above, is illustrated. It should be appreciated that other devices utilized by customers, merchants, payment service providers, account providers, and/or system providers in the system discussed above may be implemented as the computer system 1100 in a manner as follows.

In accordance with various embodiments of the present disclosure, computer system 1100, such as a computer and/or a network server, includes a bus 1102 or other communication mechanism for communicating information, which interconnects subsystems and components, such as a processing component 1104 (e.g., processor, micro-controller, digital signal processor (DSP), etc.), a system memory component 1106 (e.g., RAM), a static storage component 1108 (e.g., ROM), a disk drive component 1110 (e.g., magnetic or optical), a network interface component 1112 (e.g., modem or Ethernet card), a display component 1114 (e.g., CRT or LCD), an input component 1118 (e.g., keyboard, keypad, or virtual keyboard), a cursor control component 1120 (e.g., mouse, pointer, or trackball), a location determination component 1122 (e.g., a Global Positioning System (GPS) device as illustrated, a cell tower triangulation device, and/or a variety of other location determination devices known in the art), and/or a camera component 1123. In one implementation, the disk drive component 1110 may comprise a database having one or more disk drive components.

In accordance with embodiments of the present disclosure, the computer system 1100 performs specific operations by the processor 1104 executing one or more sequences of instructions contained in the memory component 1106, such as described herein with respect to the user devices, merchant devices, beacon devices, account provider devices, payment service provider device, and/or system provider device. Such instructions may be read into the system memory component 1106 from another computer readable medium, such as the static storage component 1108 or the disk drive component 1110. In other embodiments, hard-wired circuitry may be used in place of or in combination with software instructions to implement the present disclosure.

Logic may be encoded in a computer readable medium, which may refer to any medium that participates in providing instructions to the processor 1104 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1110, volatile media includes dynamic memory, such as the system memory component 1106, and transmission media includes coaxial cables, copper wire, and fiber optics, including wires that comprise the bus 1102. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1100. In various other embodiments of the present disclosure, a plurality of the computer systems 1100 coupled by a communication link 1124 to the network 914 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1100 may transmit and receive messages, data, information and instructions, including one or more programs (i.e., application code) through the communication link 1124 and the network interface component 1112. The network interface component 1112 may include an antenna, either separate or integrated, to enable transmission and reception via the communication link 1124. Received program code may be executed by processor 1104 as received and/or stored in disk drive component 1110 or some other non-volatile storage component for execution.

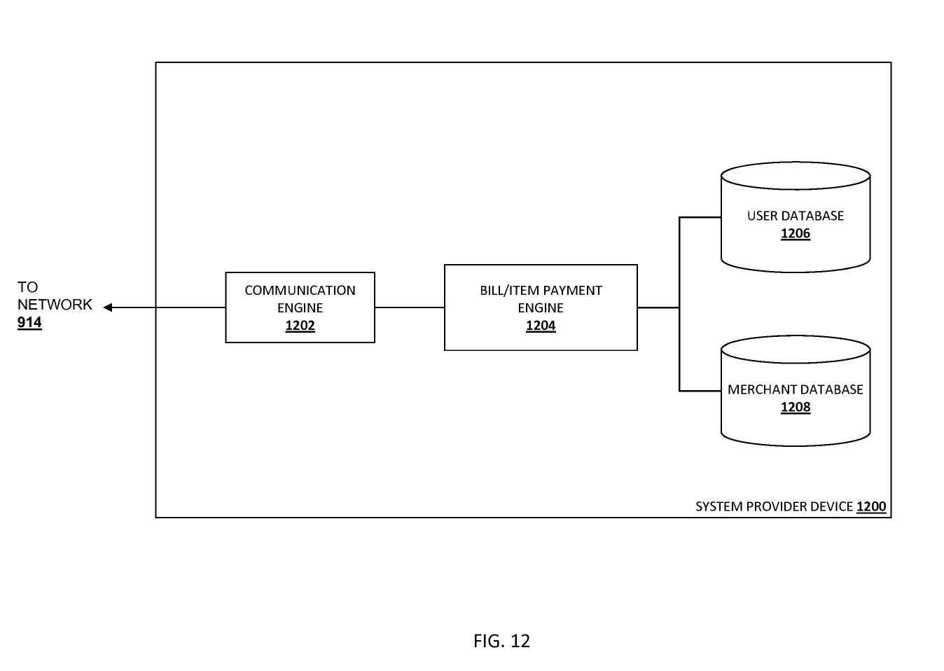

Referring now to FIG. 12, an embodiment of a system provider device 1200 is illustrated. In an embodiment, the device 1200 may be the system provider devices discussed above. The device 1200 includes a communication engine 1202 that is coupled to the network 914 and to a bill paying engine 1204 that is coupled to a user database 1206 and a merchant database 1208. The communication engine 1202 may be software or instructions stored on a computer-readable medium that allows the device 1200 to send and receive information over the network 914. The bill payment engine 1204 may be software or instructions stored on a computer-readable medium that is configured to cause a processor to receive find-users requests from first user devices, determine second user devices that are located at a physical merchant location, retrieve second user information, provide second user information to first user devices, receive purchase requests from first user devices, receive purchase request confirmations/authorizations from first user devices, second user devices, and/or merchant devices, transfer payment amounts between user accounts and merchant accounts, and/or provide any of the other functionality that is discussed above. While the user database 1206 and the merchant database 1208 have been illustrated as separate databases that are located in the device 1200, one of skill in the art will recognize that they may include fewer or more databases and be connected to the bill payment engine 1204 through the network 914 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A bill/item payment-for-another system, comprising:
a non-transitory memory storing first user information, second user information, and merchant information;
one or more hardware processors coupled to the memory and configured to read instructions from the memory to perform the steps of:
receiving a find-users request that is directed to a physical merchant location associated with the merchant information from a first user device over a network;
determining that a second user device is located at a physical merchant location;
retrieving the second user information from the non-transitory memory using an identifier of the second user device;
providing the second user information over a network for display on a first user device that is associated with the first user information;
receiving a purchase request over the network from the first user device of at least one item for a second user that is associated with the second user information; and
transferring a payment amount for the at least one item from a first user account that is associated with the first user information to a merchant account that is associated with the merchant information.

2. The system of claim 1, wherein the one or more hardware processors are further configured to read instructions from the memory to perform the steps of:
wherein the physical merchant location is identified in the find-users request.

3. The system of claim 1, wherein the physical merchant location is retrieved using a current location of the first user device that is included in the find-users request and received over the network.

4. The system of claim 1, wherein the one or more hardware processors are further configured to read instructions from the memory to perform the steps of:
retrieving a bill that is associated with the merchant and the second user, wherein the bill includes the at least one item; and
providing the bill over the network for display on the first user device.

5. The system of claim 1, wherein the one or more hardware processors are further configured to read instructions from the memory to perform the steps of:
retrieving a menu that is associated with the merchant, wherein the menu includes the at least one item; and
providing the menu over the network for display on the first user device.

6. The system of claim 1, wherein the one or more hardware processors are further configured to read instructions from the memory to perform the steps of:
providing the purchase request over the network for display on the second user device, wherein the payment amount is transferred in response to receiving an authorization over the network from the second user device.

7. A method for paying for a bill/item of another, comprising:
receiving, by a system provider device from a first user device over a network, a find-users request that is directed to a physical merchant location associated with merchant information in a database;
determining, by the system provider device, that a second user device is located at a physical merchant location;
retrieving, by the system provider device using an identifier of the second user device, second user information from the database;
providing, by the system provider device, the second user information over a network for display on the first user device that is associated with first user information in the database;
receiving, by the system provider device, a purchase request over the network from the first user device of at least one item for a second user that is associated with the second user information; and
transferring, by the system provider device, a payment amount for the at least one item from a first user account that is associated with the first user information to a merchant account that is associated with the merchant information.

8. The method of claim 7, further comprising:
providing, by the system provider device, at least one file link over the network for display on the second user device, wherein the payment amount for the at least one item is transferred from the first user account to the merchant account at least in part in response to the selection of the at least one file link.

9. The method of claim 7, wherein the physical merchant location is retrieved using a current location of the first user device that is received by the system provider device over the network.

10. The method of claim 7, further comprising:
receiving, by the system provider device, item information identifying the at least one item; and
retrieving, by the system provider device, a menu that is associated with the merchant, wherein the menu includes the at least one item; and
determining the at least one item using the item information and the menu.

11. The method of claim 7, further comprising:
providing, by the system provider device, the purchase request over the network for display on a merchant device that is associated with the merchant information, wherein the payment amount is transferred from the first user account to the merchant account in response to receiving an authorization over the network from the merchant device.

12. The method of claim 7, further comprising:
providing, by the system provider device, a bill receipt over the network for display on the second user device, wherein the bill receipt is configured to display identifying information about a first user that is associated with the first user information.

13. The method of claim 12, wherein the bill receipt is configured to display item information about the at least one item.

14. A non-transitory machine-readable medium comprising a plurality of machine-readable instructions which, when executed by one or more processors, are adapted to cause the one or more processors to perform a method comprising:
receiving a find-users request that is directed to a physical merchant location associated with merchant information in a database from a first user device over a network;
determining that a second user device is located at a physical merchant location that is associated with merchant account information in the database;
retrieving second user information from the database using an identifier of the second user device;
providing the second user information over a network for display on a first user device that is associated with first user information in the database;
receiving a purchase request over the network from the first user device of at least one item for a second user that is associated with the second user information; and
transferring a payment amount for the at least one item from a first user account that is associated with the first user information to a merchant account that is associated with the merchant information.

15. The non-transitory machine-readable medium of claim 14, wherein the method further comprises:
determining a price of the at least one item; and
sending a confirmation request that includes the price of the at least one item over the network to the first user device, wherein the payment amount is transferred in response to receiving a confirmation over the network from the first user device.

16. The non-transitory machine-readable medium of claim 14, wherein the physical merchant location is retrieved using a current location of the first user device that is received over the network.

17. The non-transitory machine-readable medium of claim 14, wherein the payment amount is transferred in response to determining that a predetermined amount of time has not passed subsequent to receiving the purchase request.

18. The non-transitory machine-readable medium of claim 14, wherein the method further comprises:
providing, by the system provider device, an advertisement over the network to the second user device, wherein the payment amount for the at least one item is transferred from the first user account to the merchant account at least in part in response to determining that the advertisement has been viewed on the second user device.

19. The non-transitory machine-readable medium of claim 18, wherein the method further comprises:
providing a bill receipt over the network for display on the second user device, wherein the bill receipt is configured to display identifying information about a first user that is associated with the advertisement.

20. The non-transitory machine-readable medium of claim 14, wherein the payment amount is transferred in response to receiving an authorization over the network from the second user device to pay for at least one other item using a second user account associated with the second user information.
